(19) United States
(12) Patent Application Publication
(10) Pub. No.: US 2008/0089233 A1
(43) Pub. Date: Apr. 17, 2008

(54) TRAFFIC CONTROL SYSTEM AND MANAGEMENT SERVER

(76) Inventors: Toshio Shimojo, Sagamihara (JP); Yoshinori Watanabe, Chigasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/866,586

(22) Filed: Oct. 3, 2007

(30) Foreign Application Priority Data
Oct. 4, 2006 (JP) 2006-272407
May 30, 2007 (JP) 2007-142771

(51) Int. Cl. H04L 12/56

(52) U.S. Cl. 370/236

(57) ABSTRACT

When abnormal traffic is detected, an abnormal traffic detection apparatus that detects the abnormal traffic reports information of the detected abnormal traffic to a management server. The management server specifies a user transmitting he abnormal traffic from an authentication server by using transmitting user information of the abnormal traffic contained in the abnormal traffic information reported. An abnormal traffic countermeasure method for each user, that is prescribed in advance and corresponds to a user transmitting the abnormal traffic, is transmitted to the abnormal traffic detection apparatus. The abnormal traffic detection apparatus executes setting for traffic control in accordance with the countermeasure method.

### BACKGROUND OF THE INVENTION

1. Field of the Invention

This invention relates to a traffic control system for managing traffic in a network. More particularly, the invention relates to a traffic control system for controlling abnormal traffic in a network.

2. Description of the Related Art

The Internet has been established steadily in the society in recent years. Technology analogous to the Internet has been used in enterprises and public institutions and an environment analogous to the Internet has been constructed as an environment dedicated to each organization. In consequence, attacks of malignant programs such as viruses and worms to servers inside a system and attacks by malignant users to the servers have become severer and severer in the same way as in the Internet. It is therefore important how to detect and control the attacks to the network and to secure stability of normal communication.

An intrusion detection system is known as a typical technology for such a problem (refer to “Intrusion Detection and Prevention”, C. Endorf, E. Schulz, J. Mellander, C. F. Endorf; McGraw-Hill. 2003/12, ISBN 0072229543, for example). This technology stores in advance patterns of abnormal packets as a database and compares the packet received with the content of the database to detect the abnormal packet.

Another technology examines the possibility of infection with a computer virus or worm from the set condition of a user terminal used by a user before connection of the user terminal to the network, isolates the user terminal in which infection may exist and takes appropriate countermeasures (Refer to “Implementing Network Admission Control Phase One Configuration and Deployment”, OL-7079-01, Version 1.1, 2005, Cisco System Catalogs). This technology can prevent the attack of the user terminal infected with the computer virus or worm to the server inside the system.

Another technology for cop9ng with the worm detects a packet of worm transmitted from a terminal infected with the worm while the user terminal is connected to a network and prevents transmission of the attack packet of the worm (“Network Security Appliance WormGuard CA”, 2006 February, NEC Catalog).

### SUMMARY OF THE INVENTION

The first known technology described above can specify the terminal that transmits a flow attacking the network inside the system but cannot specify the user using the terminal that transmits the flow. Therefore, it is not possible to employ a countermeasure for each user.

The second prior art technology, Cisco System Catalogs, described above can take a countermeasure immediately before the user terminal used by the user is connected to the network. Since it is the system that takes the countermeasure before the terminal is connected to the network, however, this technology cannot be employed in the case where the user terminal is connected to the network and is infected with the computer virus or worm while using the network.

The third prior art technology can identify the terminal infected with the worm and can take the countermeasure for each terminal infected. Since the technology cannot specify the user that uses the infected terminal, however, it cannot take a countermeasure for each user.

It is therefore an object of the invention to provide a traffic control system that specifies a user transmitting an abnormal traffic and executes traffic control in accordance with an abnormal traffic countermeasure method that is set in advance for each user.

To accomplish the object described above in a traffic control system including an abnormal traffic detection apparatus and a management server, the invention employs a construction wherein the abnormal traffic detection apparatus transmits abnormal traffic information detected on the basis of flow information to the management server, and the management server stores abnormal traffic information for each user, stores a countermeasure method for coping with the abnormal traffic for each user on the basis of the abnormal traffic information transmitted, and transmits a countermeasure method corresponding to the abnormal traffic contained in the transmitted abnormal traffic information to the abnormal traffic detection apparatus.

According to the invention, it is possible to specify a user transmitting an abnormal traffic and to execute abnormal traffic control for each user.

### BRIEF DESCRIPTION OF THE DRAWINGS

FIG. 1 is a system configuration view of Embodiment 1;

FIG. 2 is an internal structural view of an abnormal traffic detection apparatus 200;

FIG. 3 is an internal structural view of an authentication server 400;

FIG. 4 is an internal structural view of a management server 300;

FIG. 5 is an abnormal traffic information table 240 on the side of the abnormal traffic detection apparatus 200;

FIG. 6 is an abnormal traffic information table 340 on the side of the management server 300;

FIG. 7 is an authentication information table 430 inside the authentication server 400;

FIG. 8 is a user information table 320 inside the management server 300;

FIG. 9 is a user history information table 330 inside the management server 300;

FIG. 10 is an abnormal traffic countermeasure method table 330 inside the management server 300;

FIG. 11 is an abnormal traffic information table 260 inside the abnormal traffic detection apparatus 200;

FIG. 12 is an operation diagram in Embodiment 1;

FIG. 13 is a system configuration view of Embodiment 2;

FIG. 14 is an internal structural view of an address management server 700;

FIG. 15 is an abnormal traffic information table 1240 on the side of the abnormal traffic detection apparatus 200 in Embodiment 2;

FIG. 16 is an abnormal traffic information table 1340 on the side of the management server 200 in Embodiment 2;

FIG. 17 is an address management table 730 inside the address management server 700;

FIG. 18 is an operation diagram in Embodiment 2;

FIG. 19 is a system configuration view of Embodiment 3;

FIG. 20 is an internal structural view of a packet relay apparatus 4300;

FIG. 21 is an internal structural view of an abnormal traffic detection apparatus 4400;

FIG. 22 is an internal structural view of management server 4500;

FIG. 23 is an internal structural view of an authentication server 4600;

FIG. 24 is an abnormal traffic information table 4430 inside the abnormal traffic detection apparatus 4400;

FIG. 25 is packet transfer information table 4320 inside the packet relay apparatus 4300;

FIG. 26 is interface information table 4330 inside the packet relay apparatus 4300;

FIG. 27 is authentication information table 4630 inside an authentication server 4600;

FIG. 28 is user information table 4520 inside the management server 4500;

FIG. 29 is packet transfer information table 4530 inside the management server 4500;

FIG. 30 is interface information table 4550 inside the management server 4500;

FIG. 31 is topology information table 4540 inside the management server 4500;

FIG. 32 is an operation diagram at the time of the change of packet transfer information in Embodiment 3;

FIG. 33 is an operation diagram at the time of detection of the abnormal traffic in Embodiment 3;

FIG. 34 is a system configuration view of Embodiment 4;

FIG. 35 is an internal structural view of a management server 6300;

FIG. 36 is an internal structural view of a directory server 6700;

FIG. 37 is a user detailed information table 6350 inside the management server 6300;

FIG. 38 is a user detailed information table 6730 inside the directory server 6700;

FIG. 39 is an operation diagram at the time of detection of the abnormal traffic in Embodiment 4;

FIG. 40 is a system configuration view in Embodiment 5;

FIG. 41 is an internal structural view of a management server 8500;

FIG. 42 is an abnormal traffic countermeasure method table 8560 inside the management server 8500; and

FIG. 43 is an operation diagram at the time of detection of the abnormal traffic in Embodiment 5.

### DESCRIPTION OF THE EMBODIMENTS

Preferred embodiments of the invention will be hereinafter explained in detail with reference to the accompanying drawings.

### Embodiment 1

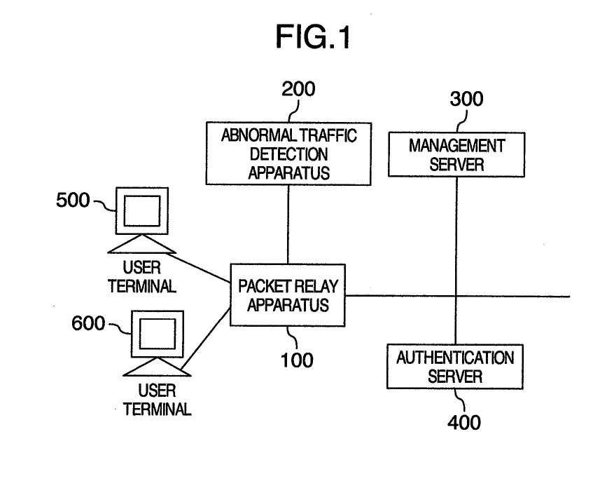

FIG. 1 shows a structural example of a network of a system for detecting and coping with abnormal traffic information for each user in the first embodiment of the invention. In the drawing, reference numeral 100 denotes a packet relay apparatus. Reference numeral 200 denotes an abnormal traffic detection apparatus. Reference numeral 300 denotes a management server for managing the present system. Reference numeral 400 denotes an authentication server for authenticating the user connected to the network. Reference numerals 500 and 600 denote user terminals connected by the users to the network.

In the network of the embodiment shown in FIG. 1, the packet relay apparatus 100 is connected to the user terminals 500 and 600. The authentication server 400 executes authentication when the users connect to the network through the user terminals 500 and 600. Under this state, the abnormal traffic detection apparatus 200 monitors communication in the network inside the system from the user terminals 500 and 600 through the packet relay apparatus 100 on the basis of flow information acquired from the packet relay apparatus 100. When detecting any abnormal traffic in the traffic transmitted and received through the user terminals 500 and 600, the abnormal traffic detection apparatus 200 executes setting of countermeasure to cope with the abnormal traffic for each user in accordance with the content set by the management server 300 for the abnormal traffic detection apparatus 200.

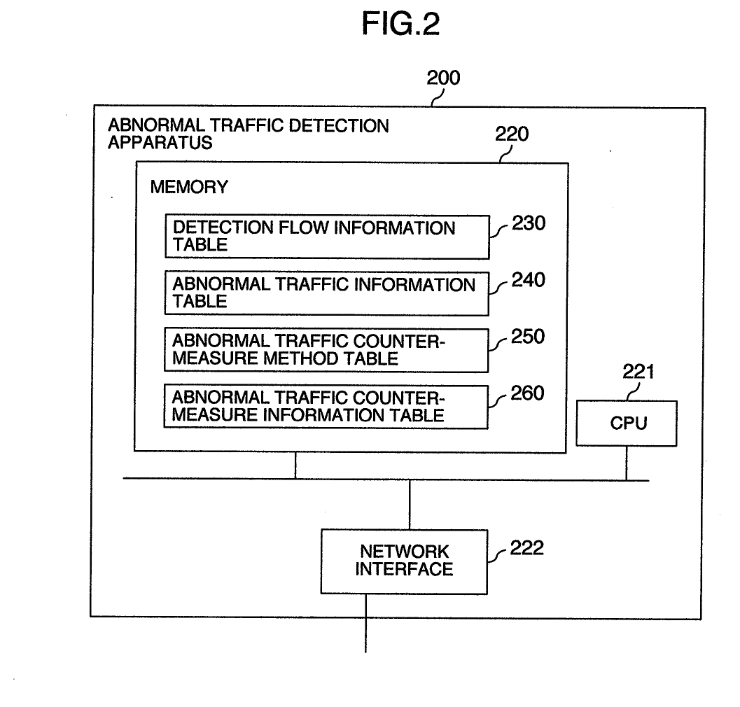

FIG. 2 shows the internal structure of the abnormal traffic detection apparatus 200. The abnormal traffic detection apparatus 200 includes a memory 220, a CPU 221 and a network interface 222. The memory 220 builds up the flow information received from the packet relay apparatus 100 and keeps detection flow information table 230 for analyzing the abnormal traffic, abnormal traffic information table 240 for recording the abnormal traffic detected, abnormal traffic countermeasure method table 250 storing a set content for the detected abnormal traffic received from the management server 300 shown in FIG. 1 and abnormal traffic countermeasure information table 260 for recording the detection content of the detected abnormal traffic, the set content for coping with the abnormal traffic and its condition.

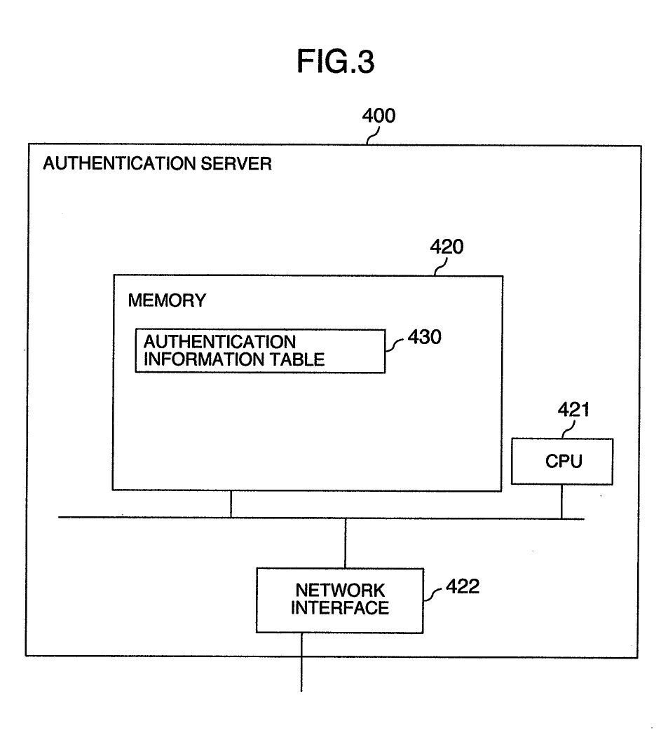

FIG. 3 shows the internal structure of the authentication server 400. The authentication server 400 includes a memory 420, a CPU 421 and a network interface 422. The memory 420 stores authentication information 430 recording the user information, the addresses unique to the user terminals 500 and 600 used by the user as shown in FIG. 1 and the authentication condition.

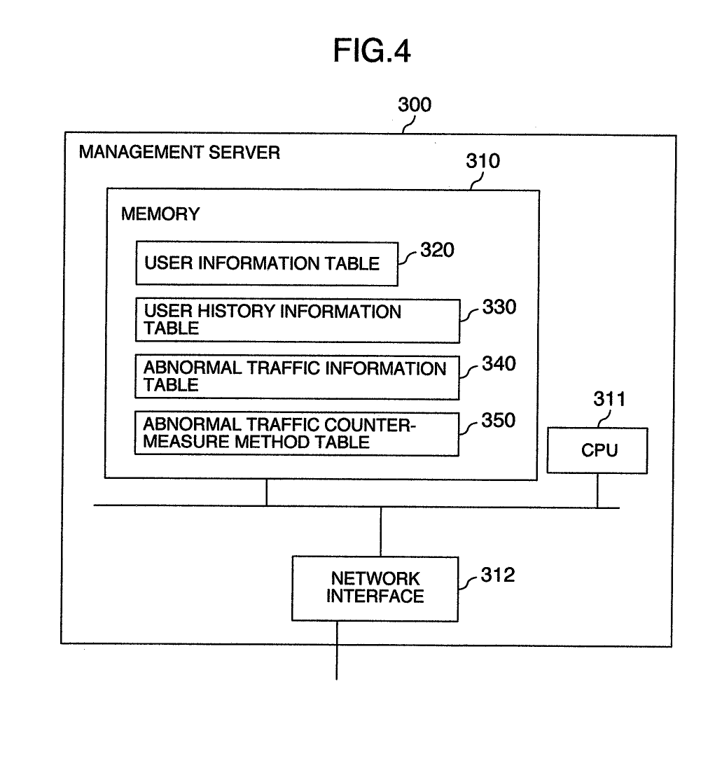

FIG. 4 shows the internal structure of the management server 300. The management serve 300 includes a memory 310, a CPU 311 and a network interface 312. The memory 310 includes user information table 320 for recording the user information, the address unique to the user terminal used by the user, the IP address allocated to the user terminal and the countermeasure condition for the user abnormal traffic, user history information table 330 for recording the content of the abnormal traffic transmitted and received by each user and the detection time of the abnormal traffic for each user, abnormal traffic information table 340 for recording the content of the detected abnormal traffic for each abnormal traffic detection apparatus, and abnormal traffic countermeasure method table 350 for holding the countermeasure method for each user against the detected abnormal traffic.

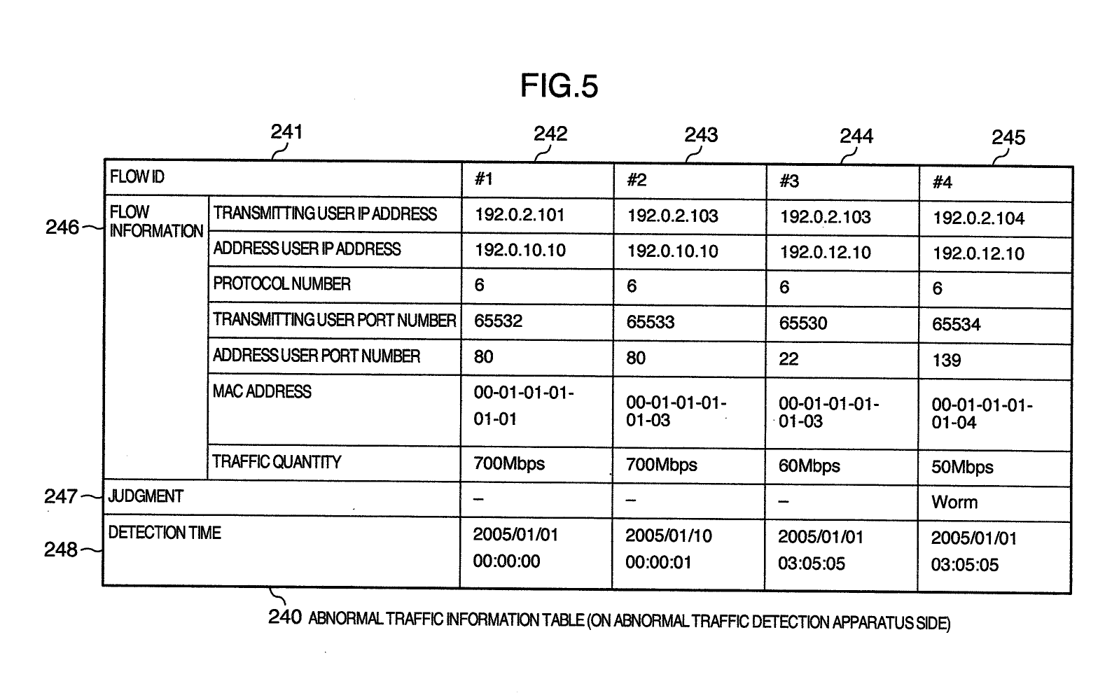

FIG. 5 shows a structure of an abnormal traffic information table 240 held by the abnormal traffic detection apparatus 200. The abnormal traffic information table 240 includes flow ID as identification information of a flow, flow information 246, flow judgment 247 representing the judgment content of the flow, and detection time 248 representing the detection time of the flow of the abnormal traffic. As shown in FIG. 5, the flow information 246 contains transmitting user IP address, address user IP address, protocol number, transmitting port number, address port number, MAC address and traffic quantity. Reference numerals 242 to 245 denote data stored in the abnormal traffic information table 240.

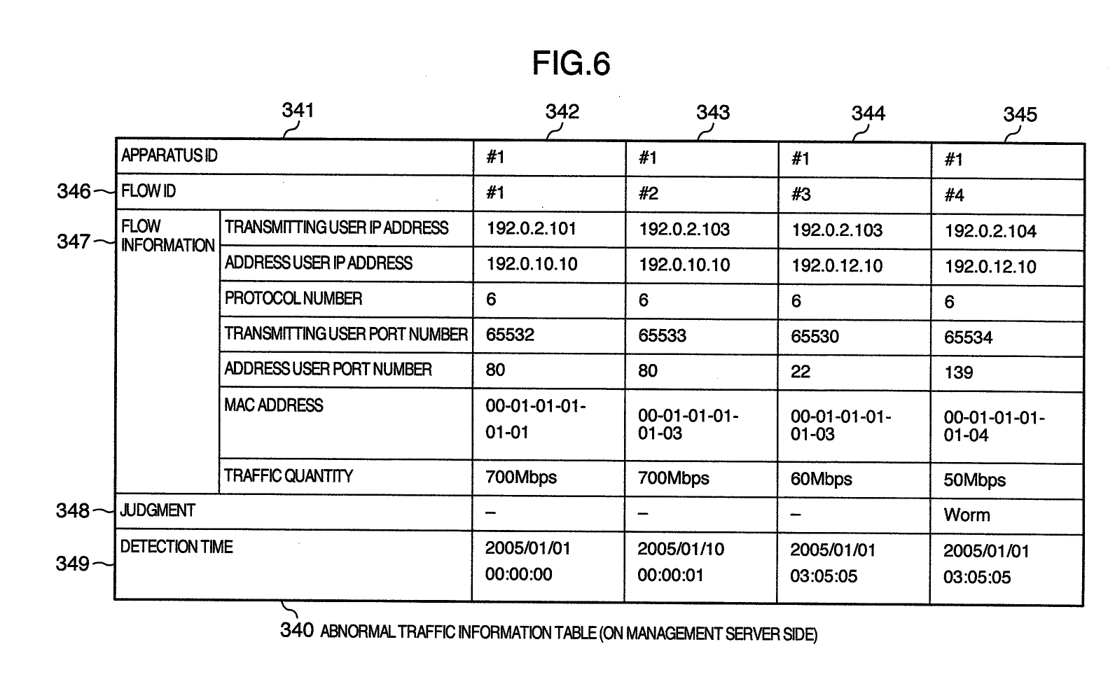

FIG. 6 shows a structure of abnormal traffic information table 340 held by the management server 300. The abnormal traffic information table 340 includes an apparatus ID 341 as identification information for identifying the abnormal traffic detection apparatus 200 detecting the flow, flow ID 346 as identification information of the flow, flow information 347, flow judgment 348 representing the judgment content of the flow, and detection time 349 representing the detection time of the flow of the abnormal traffic. The abnormal traffic information table 340 is transmitted as a message (message containing abnormal traffic information that the abnormal traffic detection apparatus 200 has) from the abnormal traffic detection apparatus 200 and is held with an apparatus ID 346 as identification information of the abnormal traffic detection apparatus transmitting the information. As shown in FIG. 6, the flow information includes a transmitting user IP address a protocol number, a transmitting user port number, a destination port number, a MAC address and a traffic quantity. Reference numerals 342 to 345 represent data stored in the abnormal traffic information table 340.

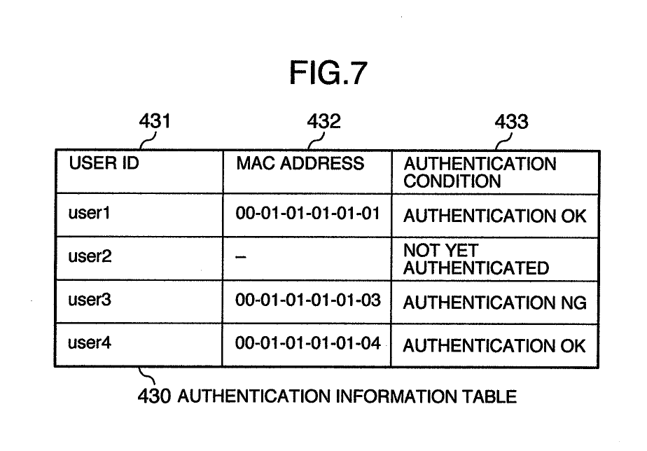

FIG. 7 shows a structure of authentication information 430 held by the authentication server 400. The authentication information 430 includes a user ID 431 for identifying a user, a MAC address 432 for identifying a user terminal used by the user and an authentication condition 433 representing the authentication result of the user.

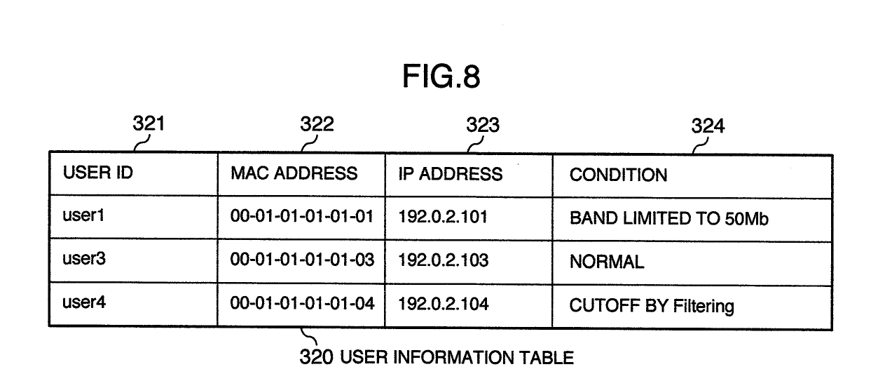

FIG. 8 shows a structure of a user information table 320 held by the management server 300. The user information table 320 includes a user ID 321 for identifying a user, a MAC address 322 as identification information of a user terminal used by the user, an IP address 323 as an IP address allocated to the user terminal and a condition 324 representing the set content of an abnormal traffic countermeasure executed by the abnormal traffic detection apparatus.

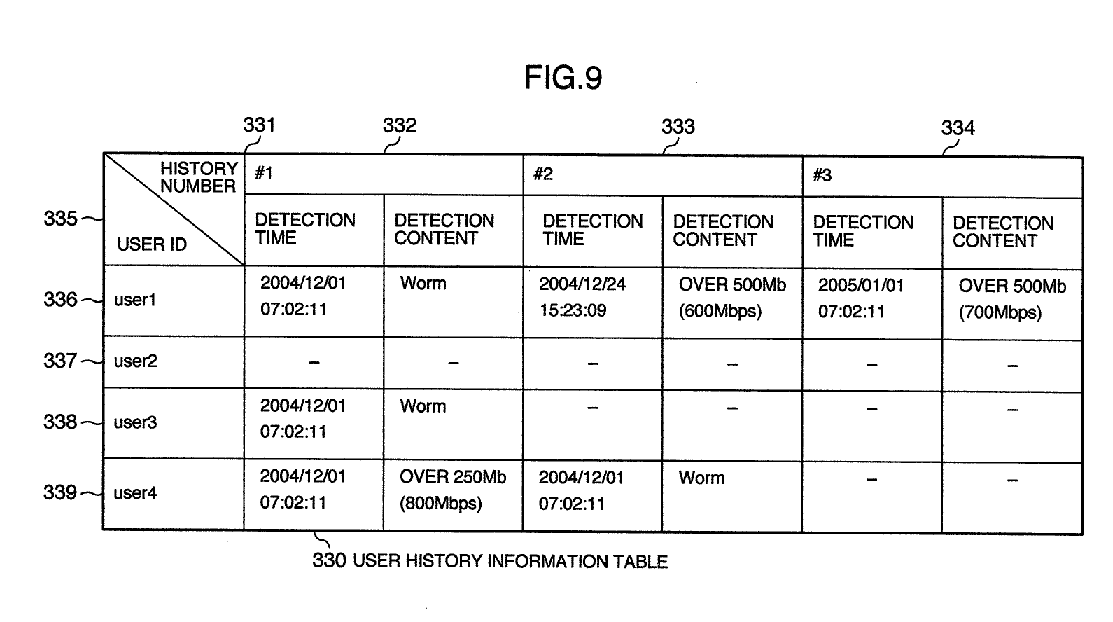

FIG. 9 shows a structure of a user history information table 330 held by the management server 300. The user history information 330 contains the content of the abnormal traffic for a user which is detected in the past and for which a countermeasure is taken, and the detection time. The user history information table 330 includes a history number 331 representing the number of the history, a user ID 335 representing the user as the object of the history information, and 332, 333 and 334 representing the detection time of the abnormal traffic and its detection content. Reference numerals 336 to 339 denote the user history information corresponding to the user user1 to user4, respectively.

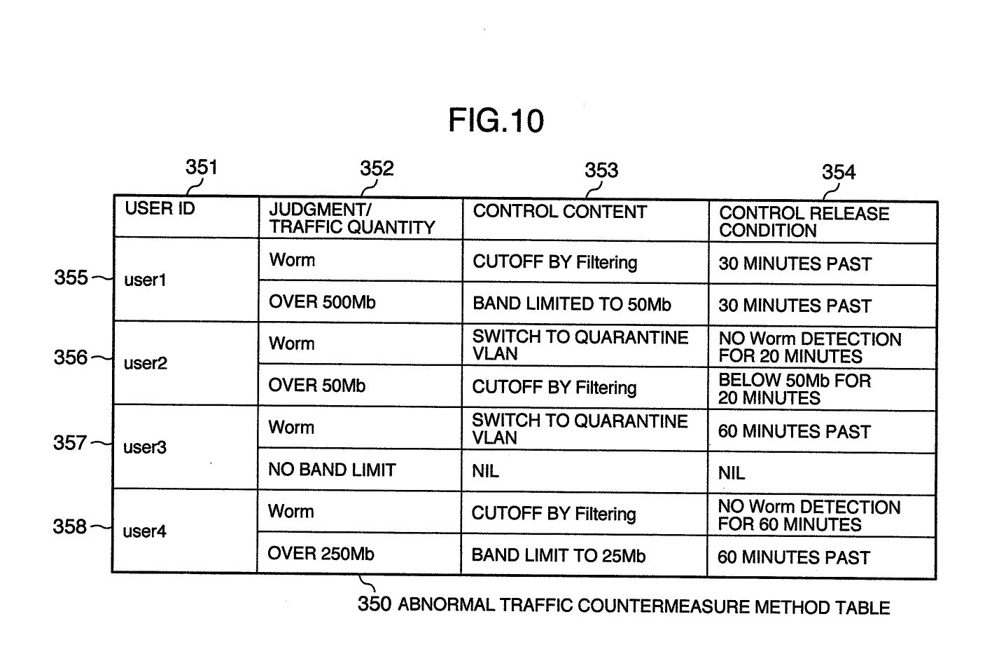

FIG. 10 shows a structure of an abnormal traffic countermeasure method table 350 held by the management server 300. The abnormal traffic countermeasure method table 350 contains a countermeasure method (solution of abnormal traffic) for each user to cope with the abnormal traffic. The abnormal traffic countermeasure method table 350 includes a user ID 351 representing the user as the object when the abnormal traffic is detected, a judgment/traffic quantity 352 representing the condition of abnormal traffic judgment, a control content 353 representing the content of the countermeasure when the abnormal traffic is detected, and a control release condition 354 representing the judgment condition when the abnormal traffic is no longer detected. Reference numerals 355 to 358 denote information about the abnormal traffic countermeasure methods corresponding to user1 to user4, respectively. As for the information 355 about the user1 in FIG. 10, for example, cutoff by filtering is executed as the countermeasure method of the abnormal traffic when the abnormal traffic of Worm is detected in the user ID user1, and 30 minutes later from this filtering, cutoff by filtering is released.

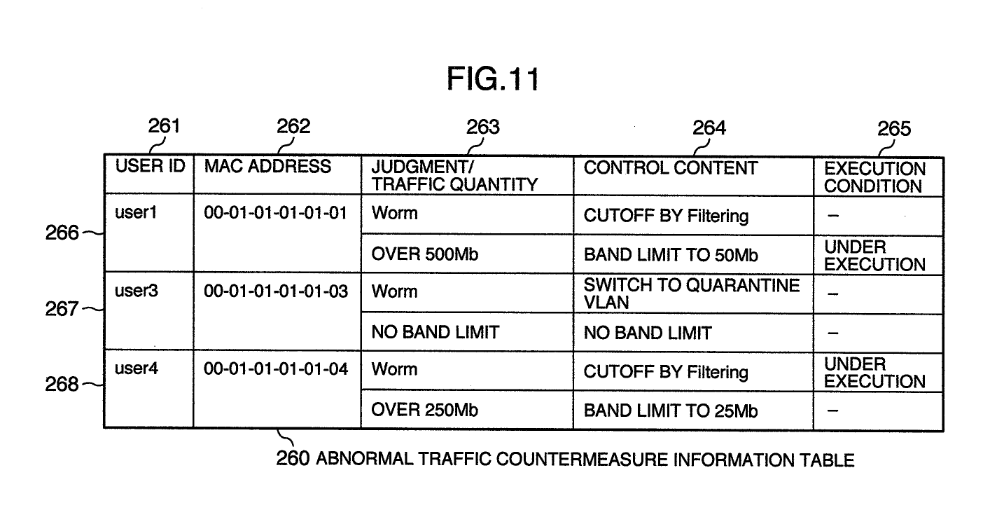

FIG. 11 shows a structure of an abnormal traffic countermeasure information table 260 used to cope with the abnormal traffic for each user which table is held by the abnormal traffic detection apparatus 200. The abnormal traffic countermeasure information table 260 includes a user ID 261 as the object of the abnormal traffic countermeasure, a MAC address 262 for primarily identifying the user terminal used by the user as the abnormal traffic countermeasure, a judgment/traffic quantity 263 as the condition for judgment of the abnormal traffic, a control content 264 as the countermeasure content when the abnormal traffic is detected, and a condition status 265 representing the condition status of the abnormal traffic. The information about the user1 in FIG. 11, for example, represents that the user having the user ID of user1 uses a user terminal of a MAC address 00-01-01-01-01-01, the abnormal traffic detection apparatus detects that a traffic exceeding 500 Mbps is communicated and the band is limited to 50 Mbps.

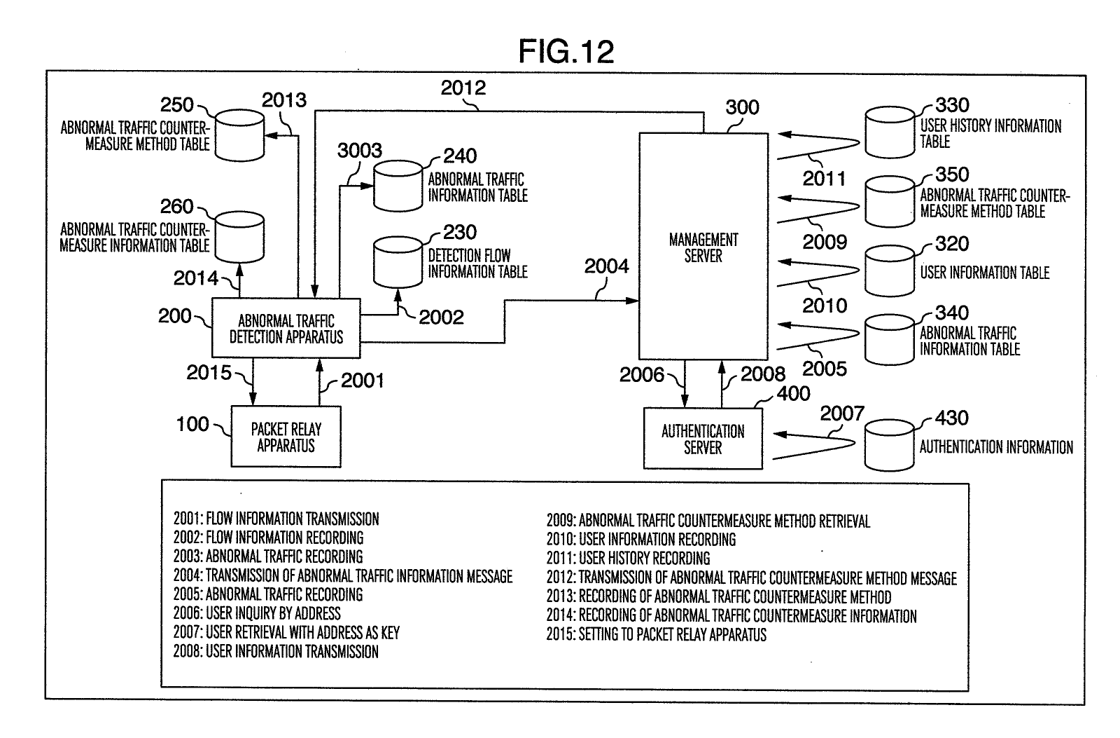

FIG. 12 shows an operation diagram of a system for detecting and coping with the abnormal traffic information for each user. This is based on the premise that authentication has already been made by the authentication server in the user terminal used by the user. Numerals of three digits in FIG. 12 represent various constituent elements or tables shown in FIGS. 1 to 4. Numerals of four digits represent the operations (or processing steps) in FIG. 12.

To begin with, the packet relay apparatus 100 transmits the packet relayed by itself in a predetermined cycle as flow information to the abnormal traffic detection apparatus 200 (step 2001). The abnormal traffic detection apparatus 200 records the flow information received from the packet relay apparatus 100 to the detection flow information table 230 (step 2002) and examines whether or not the flow information received reaches the condition of the abnormal traffic. When the flow information does not yet reach the condition of the abnormal traffic, the abnormal traffic detection apparatus 200 waits for the flow information from the packet relay apparatus 100 and repeats the steps 2001 and 2002 until the abnormal traffic condition is reached. When the flow under recording to the detection flow information table 230 reaches the abnormal traffic in the abnormal traffic detection apparatus 200, the flow ID of the flow, the flow information, the judgment result of the flow and the judgment time of the judgment as the abnormal traffic are recorded to the abnormal traffic information table 240 (step 2003), and the abnormal traffic information message 300 is transmitted (step 2004).

The management server 300 records the abnormal traffic information message it receives from the abnormal traffic detection apparatus 200 to the abnormal traffic information table 340 (step 2005). To determine from which user the abnormal traffic is transmitted, the management server 300 inquires the authentication server 400 by using the MAC address of the abnormal traffic information message (step 2006). The authentication server 400 retrieves the user corresponding to the MAC address from the authentication information 430 on the basis of the MAC address used by the user inquiry from the management server 300 (step 2007). The authentication server 400 transmits the retrieval result of the user from the authentication information 430 (user information) to the management server 300 (step 2008). To acquire the countermeasure information for the user transmitting the abnormal traffic, the management server 300 retrieves the abnormal traffic countermeasure method table 350 on the basis of the user information received in step 2008 from the authentication server 400 (step 2009). The management server 300 records the user information and the abnormal traffic countermeasure method corresponding to the user to the user information table 320 (step 2010). Furthermore, the management server 300 records the user information and the abnormal traffic information received from the abnormal traffic detection apparatus 200 (abnormal traffic information corresponding to user information) to the user history information table 330 (step 2011). The management table 300 thereafter transmits the countermeasure information for the user transmitting the abnormal traffic and retrieved from the abnormal traffic countermeasure information table 350 to the abnormal traffic detection apparatus 200 (step 2012).

The abnormal traffic detection apparatus 200 records the countermeasure information for the user transmitting the abnormal traffic and received from the management server 300 in step 2012 to the abnormal traffic countermeasure method table 250 (step 2013). The abnormal traffic detection apparatus 200 records the countermeasure information of the abnormal traffic and its execution condition to the abnormal traffic countermeasure information table 260 that records the condition of the abnormal traffic countermeasure for each user (step 2014). The abnormal traffic detection apparatus 200 executes setting corresponding to the content of the countermeasure to the packet relay apparatus 100.

In this embodiment, the abnormal traffic countermeasure method for each user is set in advance by the management server 300 and the user terminal of the user transmitting the abnormal traffic and its traffic are specified by making the inquiry of the information of the abnormal traffic reported from the abnormal traffic detection apparatus 200. Furthermore, the abnormal traffic countermeasure method of the user transmitting the abnormal traffic is transmitted to the abnormal traffic detection apparatus. It becomes thus possible to execute unitary control of the abnormal traffic for each user.

The past abnormal traffic detected by the abnormal traffic detection apparatus is preserved with the detection time as history information for each user by the management server 300. Therefore, a manager of an intra-system network can know which abnormal traffic is transmitted in the past by the user and the information can be reflected on the abnormal traffic countermeasure method for each new user from this history information.

Other application examples of this embodiment are listed below.

(1) In a network system which includes an abnormal traffic detection apparatus for receiving a measurement result of traffic information from a packet relay apparatus and an authentication server for authenticating a user and in which a user terminal connected beforehand to the network is under the authentication state by the authentication server, a traffic management server which inquires information of an abnormal traffic flow reported from the abnormal traffic detection apparatus and a transmitting user address of the abnormal traffic flow to the authentication server by using information in advance prescribed for the countermeasure against the abnormal traffic for each user, stipulates the user transmitting the abnormal traffic flow, and instructs setting against the abnormal traffic of the traffic flow of the stipulated user to the traffic detection apparatus.

(2) A traffic management server described in (1), which holds information of the abnormal traffic flow prescribed in advance for each user, specifies a user transmitting the abnormal traffic flow by making inquiry to the authentication server by using the information of the abnormal traffic flow reported from the abnormal traffic detection apparatus and the transmitting user address of the abnormal traffic flow and instructs setting against the abnormal traffic flow transmitted by the user so specified to the abnormal traffic detection apparatus.

(3) A traffic management server described in (2), which records the abnormal traffic flow reported from the abnormal traffic detection apparatus and the user transmitting the traffic flow abnormality as history for each user.

Still other application examples are listed below.

(4) To specify the user that transmits the abnormal traffic, the abnormal traffic detection apparatus transmits the information of the abnormal traffic upon detecting the abnormal traffic, to the management server controlling the abnormal traffic for each user. To specify the user transmitting the abnormal traffic, the management server makes inquiry to the authentication server for managing authentication executed at the time of connection of the user to the network, by using the transmitting user address of the abnormal traffic. Furthermore, the management server retrieves the countermeasure against the abnormal traffic of the user transmitting the abnormal traffic from the abnormal traffic countermeasure content prescribed in advance for each user on the basis of the user information acquired from the authentication server, and reports this countermeasure method to the abnormal traffic detection apparatus. The abnormal traffic detection apparatus executes setting against the abnormal traffic to the packet relay apparatus in accordance with the abnormal traffic countermeasure method reported.

(5) To execute traffic control for the user transmitting the abnormal traffic, a table describing the content of the abnormal traffic for each user is provided for each user.

(6) To accomplish long term management of the abnormal traffic for each user, the management server preserves the content of the abnormal traffic information reported from the abnormal traffic detection apparatus and the information of the user transmitting the abnormal traffic and acquired from the authentication information of the authentication server as the history for each user, and stores the history information for each user for executing the long term abnormal traffic management for each user.

### Embodiment 2

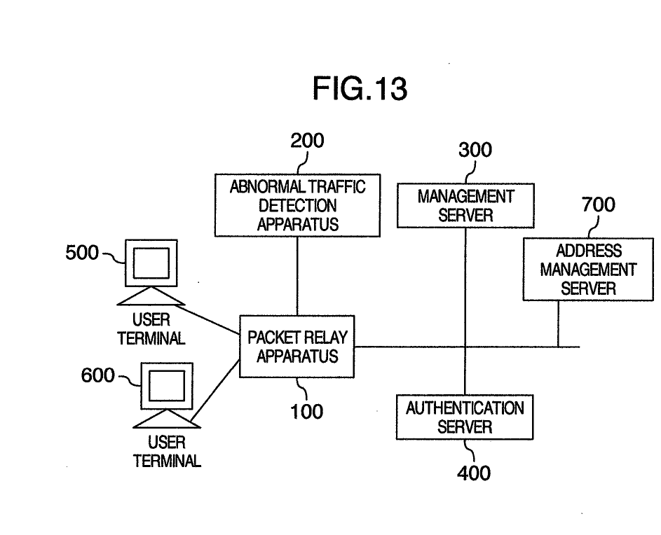

Another embodiment of the invention will be explained. FIG. 13 shows a system configuration which is constituted by adding an address management server 700 for managing IP addresses to the system shown in FIG. 1. In this system, too, a system for detecting and coping with abnormal traffic information for each user can be realized. In FIG. 13, an address management server 700 manages the IP addresses allocated to user terminals 500 and 600. Since the constituent members other than the address management server 700 in FIG. 13 are the same as those shown in FIG. 1, explanation of such members will be omitted.

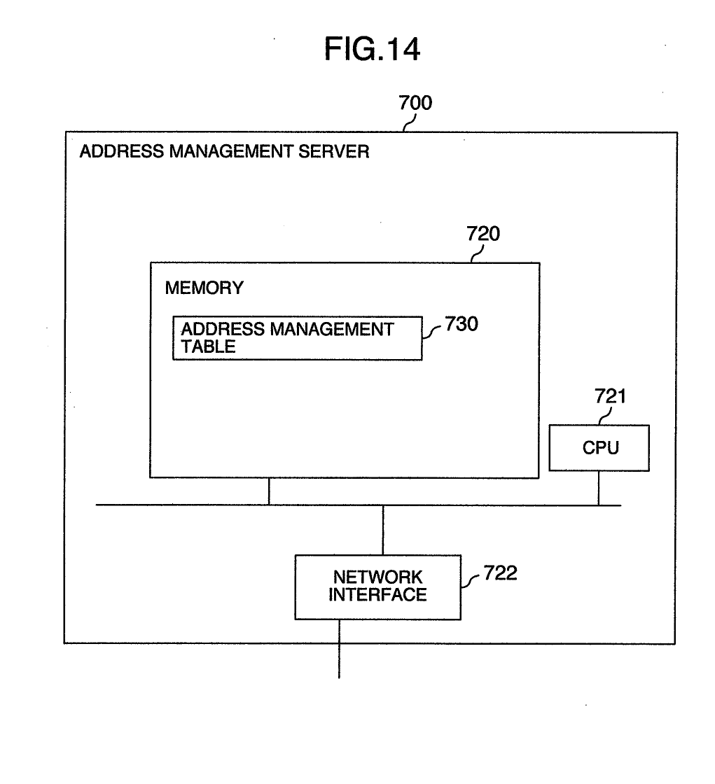

FIG. 14 shows an internal structure of the address management server 700. The address management server 700 includes a memory 720, a CPU 721 and a network interface 722. The memory 720 saves an address management table 730 for managing the IP address.

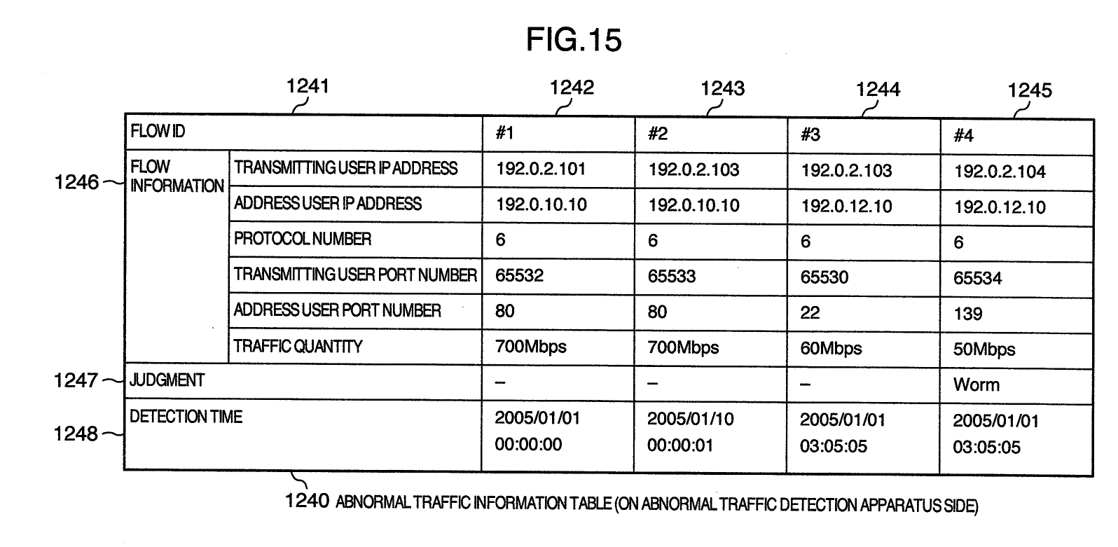

FIG. 15 shows a structure of an abnormal traffic information table 1240 held by the abnormal traffic detection apparatus 200 in this embodiment. The abnormal traffic information table 1240 includes flow information 1246, flow judgment 1247 representing a judgment content of the flow and detection time 1248 representing the detection time of the flow of the abnormal traffic. Here, the flow information 1246 includes a flow ID 1241 as an identifier of the flow, a transmitting user IP address, an address user IP address, a protocol number, a transmitting user port number, an address port number and a traffic quantity. Reference numerals 1242 to 1245 denote data stored in the abnormal traffic information table 1240.

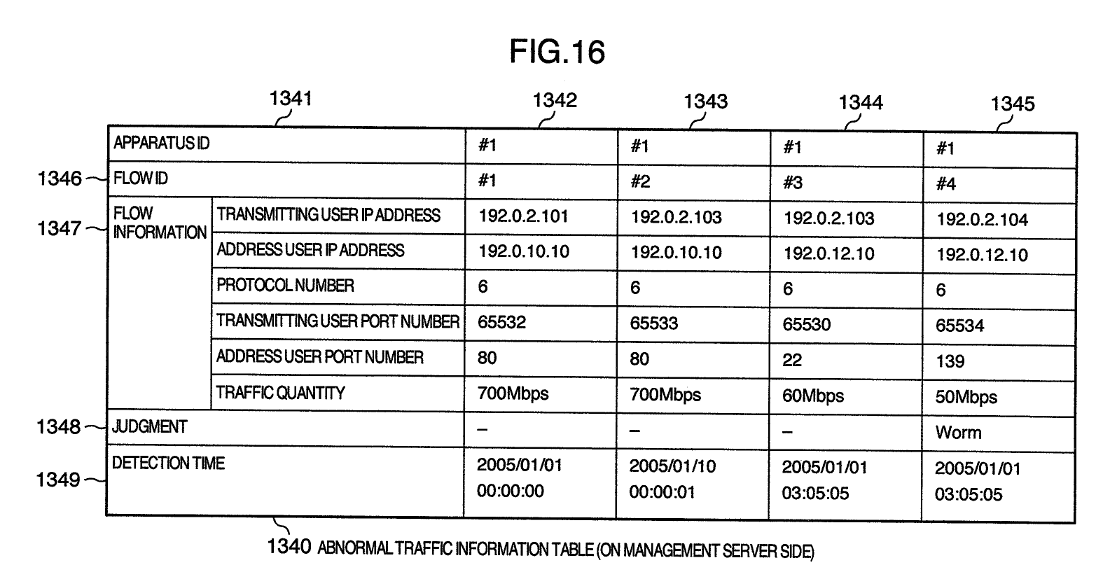

FIG. 16 shows a structure of an abnormal traffic information table 1340 held by the management server 300 in this embodiment. The abnormal traffic information table 1340 includes an apparatus ID 1341 for identifying the abnormal traffic detection apparatus that detects the flow, a flow ID 1346 as an identifier of the flow, flow information 1347, flow judgment 1348 representing the judgment content of the flow, and detection time 1349 at which the flow is detected. The abnormal traffic information table 1340 is sent in a message form from the abnormal traffic detection apparatus 200 and is held together with the ID of the abnormal traffic detection apparatus 200. Here, the flow information 1347 includes a transmitting user IP address, an address IP address, a protocol number, a transmitting port number, an address port number and a traffic quantity. Reference numerals 1342 to 1345 denote data stored in the abnormal traffic information table 1340.

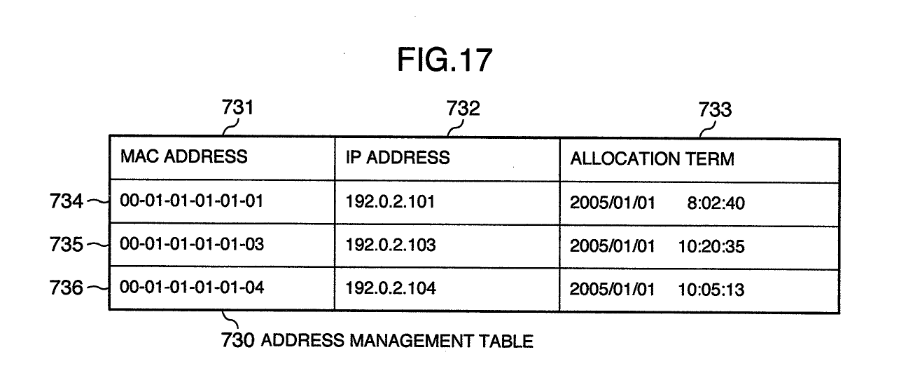

FIG. 17 shows the address management table 730 held by the address management server 700. The address management table 730 includes a MAC address 731 representing a MAC address of the terminal to which the IP address is allocated, an IP address 732 representing the IP address allocated to the user terminal and an allocation term 733 representing the valid term of the IP address allocated to the user terminal. Reference numerals 734 to 736 denote data stored in the address management table 730.

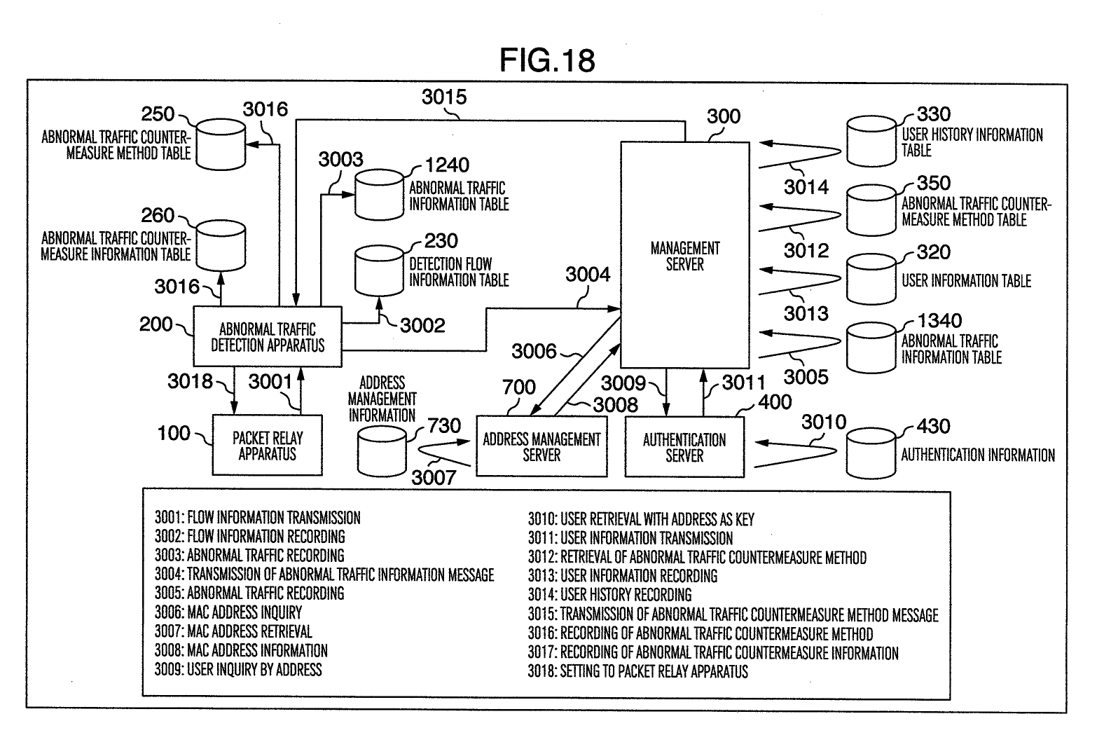

FIG. 18 shows the operation of the system according to this embodiment. It is hereby necessary as the premise that authentication has been completed by the authentication server in the user terminal used by the user and the IP address has been allocated to the user terminal from the address management server. Numerals of three digits in FIG. 18 denote the constituent elements or various tables shown in FIGS. 13 and 14 and in FIGS. 2 to 4 in the same way as in FIG. 12. Numerals of four digits denote the operations (or processing steps) in FIG. 18. The differences between FIG. 18 and FIG. 12 are that the system includes the address management server 700 and the address management information 730 and that the operations associated with these means (processing steps) are added.

The packet relay apparatus 100 transmits the packets relayed by itself in a predetermined cycle as flow information to the abnormal traffic detection apparatus 200 (step 3001). The abnormal traffic detection apparatus 200 records the flow information received from the packet relay apparatus 100 to the detection flow information table 230 (step 3002) and checks whether or not the flow information received reaches the condition of the abnormal traffic. When the condition of the abnormal traffic is not yet reached, the abnormal traffic detection apparatus 200 waits for the flow information from the packet relay apparatus 100 and repeats steps 3001 to 3002 until the condition of the abnormal traffic is reached. When the flow during recording to the detection flow information table 230 reaches the abnormal traffic in the abnormal traffic detection apparatus 200, the flow ID of this flow, the flow information, the judgment result of the flow and the judgment time of the judgment as the abnormal traffic are recorded to the abnormal traffic information table 1240 (step 3003) and transmits the abnormal traffic information message to the management server 300 (step 3004). Steps 3001 to 3004 represent the processing similar to that of steps 2001 to 2004 in FIG. 12.

The management server 300 records the abnormal traffic information message received from the abnormal traffic detection apparatus 200 to the abnormal traffic information table 1340 (step 3005). Next, to examine the user terminal transmitting the abnormal traffic, the management server 300 inquires the MAC address of the user terminal to the address management server 700 by using the transmitting user IP address of the abnormal traffic received (step 3006). The address management server 700 retrieves the corresponding MAC address from the address management information 730 by using the IP address inquired (3007 in the drawing) and returns the retrieval result to the management server 300 (3008 in the drawing). To determine from which user the abnormal traffic originates, the management server 300 makes inquiry to the authentication server 400 by using the MAC address transmitted from the address management server 700 (3009 in the drawing). The authentication server 500 retrieves the user corresponding to the MAC address from the authentication information 430 by using the MAC address used for the user inquiry from the management server 300 as a key (3010 in the drawing). The authentication server 400 transmits the user retrieval result from the authentication information 430 (user information) to the management server 300 (3011 in the drawing). To acquire the information for coping with the user transmitting the abnormal traffic, the management server 300 retrieve the abnormal traffic countermeasure method table 350 on the basis of the user information received from the authentication server 400 (3012 in the drawing) in step 3011. The management server 300 records the user information and the abnormal traffic countermeasure method corresponding to the user to the user information table 320 (3013 in the drawing). Furthermore, the management server 300 records the user information and the abnormal traffic information received from the abnormal traffic detection apparatus 200 (abnormal track information corresponding to user information) to the user history information table 330 (3014 in the drawing). The management server 300 thereafter transmits the countermeasure information for the user transmitting the abnormal traffic retrieved from the abnormal traffic countermeasure method table 350 to the abnormal traffic detection apparatus 200 (3015 in the drawing).

The abnormal traffic detection apparatus 200 records the countermeasure information for the user transmitting the abnormal traffic and received from the management server 300 in step 3015 to the abnormal traffic countermeasure method table 250 (3016 in the drawing). The abnormal traffic detection apparatus 200 records the countermeasure information against the abnormal traffic and its execution condition to the abnormal traffic countermeasure information table 260 recording the condition of the countermeasure against the abnormal traffic for each user (3017 in the drawing). The abnormal traffic detection apparatus 200 executes setting to the packet relay apparatus 100 in accordance with the content of the countermeasure (3018 in the drawing). Incidentally, steps 3009 to 3018 in FIG. 18 correspond to steps 2005 to 2015 in FIG. 12, respectively.

### Embodiment 3

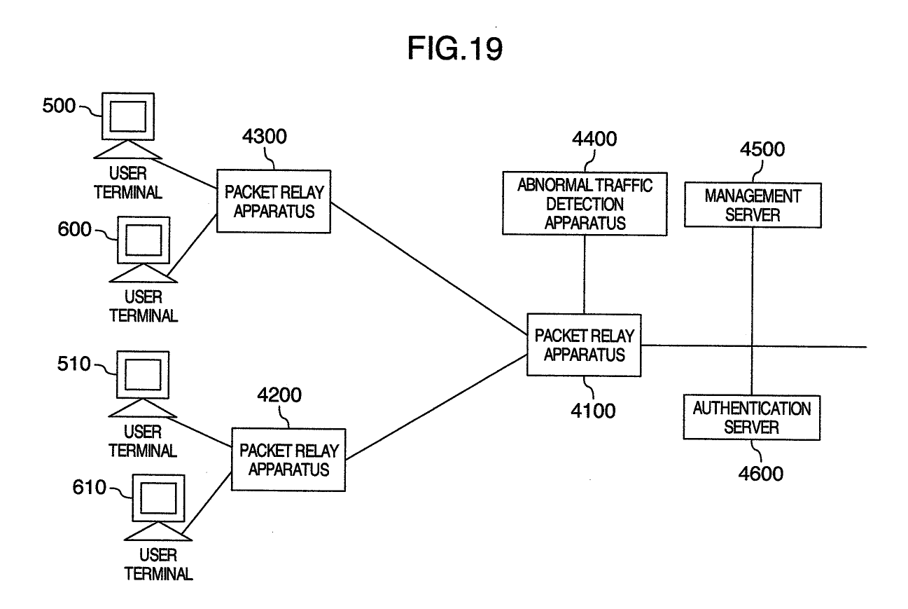

Still another embodiment of the invention will be explained. FIG. 19 shows a system configuration in the case where a plurality of packet relay apparatuses of the system shown in FIG. 1 exists and the user terminals are directly connected to the packet relay apparatuses other than the packet relay apparatus to which the abnormal traffic detection apparatus 4400 is connected. In this system, too, the system capable of detecting and coping with the abnormal traffic for each user can be executed. In the drawing, the user terminals 500 and 600 are the terminals for connecting the user to the network, the packet relay apparatus 4300 is for connecting these terminals, the packet relay apparatuses 4200 and 4400 for connecting the user terminals 510 and 610 are the abnormal traffic detection apparatus, 4100 is the packet relay apparatus for connecting the abnormal traffic detection apparatus, 4500 is a management server for executing management of this system and 4600 is an authentication server for executing authentication of the user network connection.

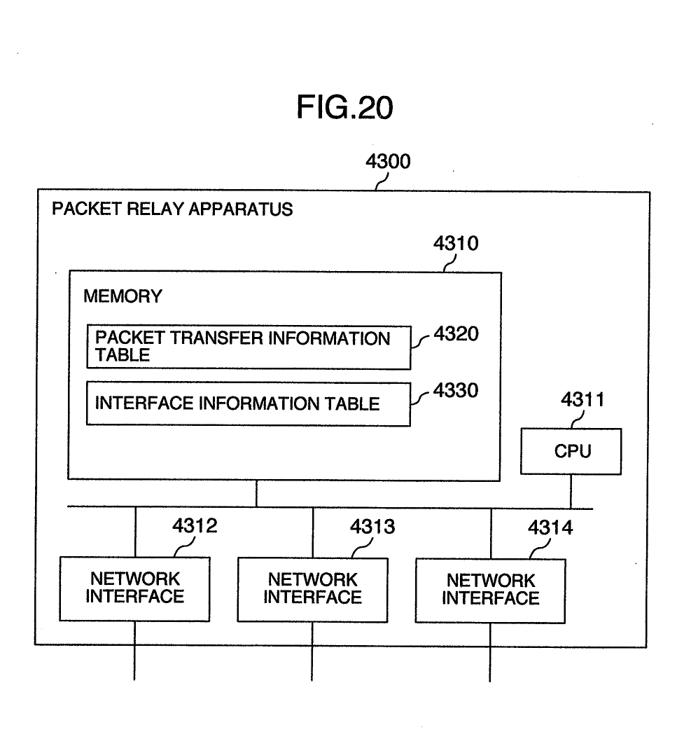

FIG. 20 shows an internal structure of the packet relay apparatus 4300 in this embodiment. The packet relay apparatus 4300 includes a memory 4310, a CPU 4311 and network interfaces 4312, 4313 and 4314 as a plurality of network interfaces. The memory 4310 stores a packet transfer information table 4320 for recording information used for transferring the packet and an interface information table 4330 for storing the condition of the network interface and its MAC address.

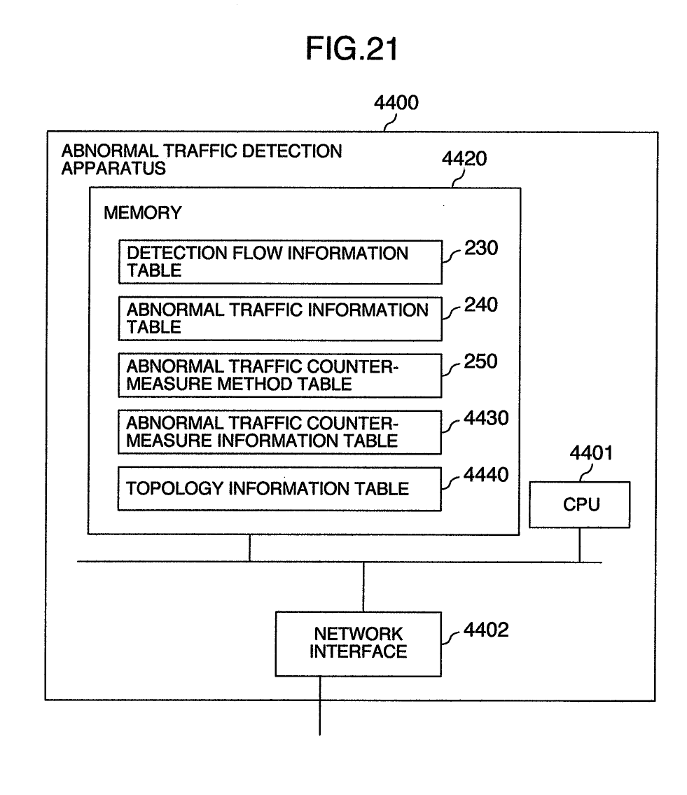

FIG. 21 shows an internal structure of the abnormal traffic detection apparatus 4400. The abnormal traffic detection apparatus 4400 includes a memory 4420, a CPU 4401 and a network interface 4402. The memory 4420 stores an abnormal traffic countermeasure information table 4430 for recording the content of the detected abnormal traffic, set content for the abnormal traffic countermeasure, its condition and the packet relay apparatus executing the countermeasure, a topology information table 4400 for storing the structure information representing which user terminal is connected to which packet relay apparatus, a detection flow information table 230, an abnormal traffic information table 240 and an abnormal traffic countermeasure method table 250. The constituent members from 230 to 250 in the drawing are the same as the abnormal traffic detection apparatus 200 shown in FIG. 2 and its explanation will be omitted.

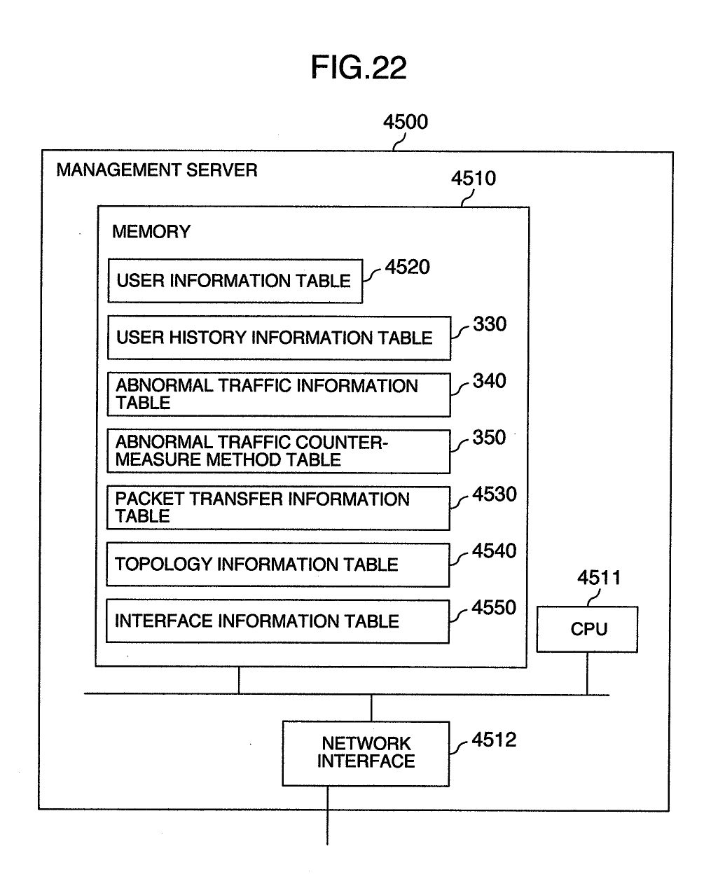

FIG. 22 shows an internal structure of the management server 4500. The memory 4510 includes a user information table 4520 for recording user information for each user, a unique address of a user terminal used by the user, an IP address allocated to the user terminal, an IP address of a packet relay apparatus connecting the user terminal and an interface in this packet relay apparatus and a content of an abnormal traffic of the user, a packet transfer information table 4520 for keeping a packet transfer information table acquired from a plurality of packet relay apparatuses, an interface information table 4550 for keeping an interface information table acquired from a plurality of packet relay apparatuses, a topology information table for keeping construction information of a network generated from the packet transfer information table and the interface information table, a user history information table 330, an abnormal traffic information table 340 and an abnormal traffic countermeasure method table 350. In the drawing, reference numerals 330 to 350 are the same as the management server 300 shown in FIG. 4. Therefore, explanation will be omitted.

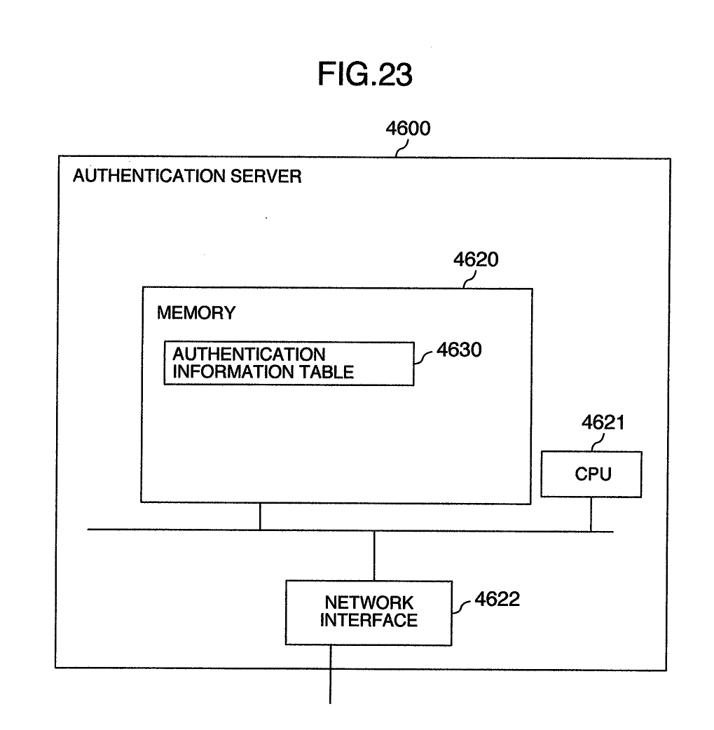

FIG. 23 shows an internal structure of an authentication server 4600. The authentication server 4600 includes a memory 4620, a CPU 4621 and a network interface 4622. The memory 4620 includes authentication information 4630 for recording the user information and the inherent addresses of the user terminals 500, 600, 510 and 610 of FIG. 19 used by the user, the packet relay apparatus executing authentication and an authentication condition of the user.

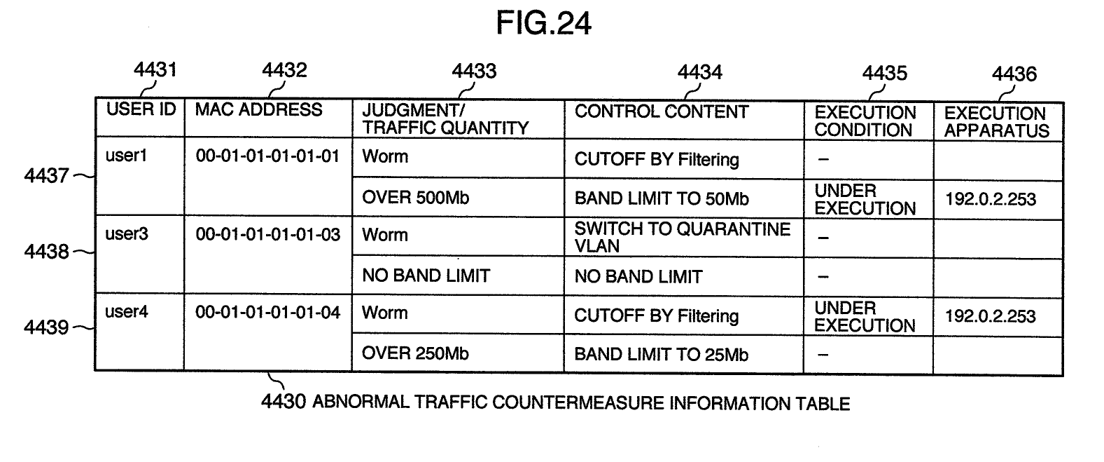

FIG. 24 shows an internal structure of the abnormal traffic countermeasure information table 4430 stored in the abnormal traffic detection apparatus shown in FIG. 21 and used for coping with the abnormal traffic of each user. The abnormal traffic countermeasure information table 4430 includes a user ID 4431 representing the user as the object of the abnormal traffic countermeasure, a MAC address 4432 as an address unique to the user terminal used by the user, a traffic quantity 4433, a control content 4434 as the content of the counter measure when the abnormal traffic is detected, an execution condition 4435 as the execution condition of the abnormal traffic countermeasure and an execution apparatus 4436 representing the packet relay apparatus to which the content for the abnormal traffic countermeasure is set. Reference numerals 4437, 4438 and 4439 in the abnormal traffic information table are the content for each user described above. For example, 437 represents the condition where the user having the user ID of user1 is detected as the abnormal traffic since it transmits and receives a traffic exceeding 500 Mpbs by using the user terminal having the MAC address of 00-01-01-01-01-01 and the transmission/reception traffic of the user is limited to 50 Mbps in the packet relay apparatus 192.02.253.

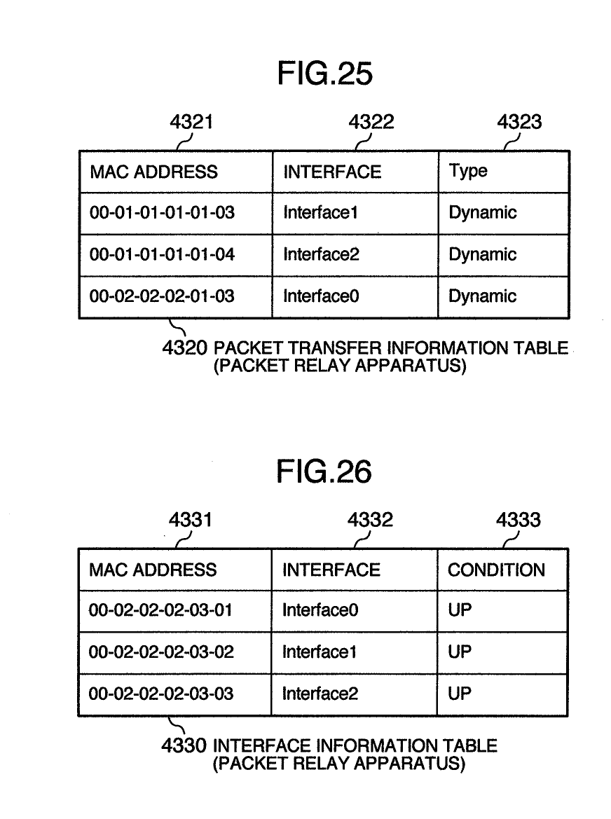

FIG. 25 shows an internal structure of a packet transfer information table 4320 that is held by the packet relay apparatus 4300 shown in FIG. 20 and is used for packet transfer. The packet transfer information table 4320 includes an interface 4322 representing a network interface of the packet relay apparatus 4300, a MAC address 4321 as unique addresses of the apparatuses connected to the interface and a Type 4323 representing a learning method of these kinds of information. It is possible to know from this packet transfer information table which apparatuses are connected to the packet relay apparatus.

FIG. 26 shows an internal structure of an interface information table 4330 held by the packet relay apparatus 4300. The interface information table 4330 includes an interface 4332 for identifying the network interface, a MAC address 4331 as a unique address of the interface and a condition 4333 representing the condition of this interface.

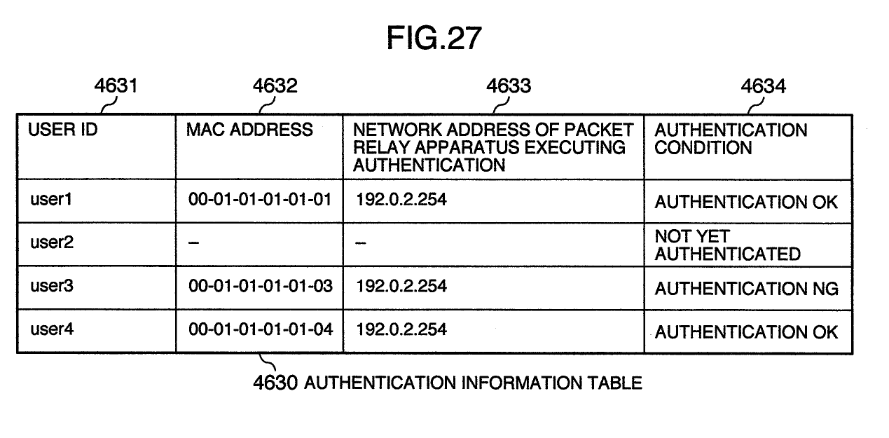

FIG. 27 shows an internal structure of an authentication information table 4630 held by the authentication server 4600. The authentication information table 4630 includes a user ID for identifying a user, a MAC address 4632 for identifying the user terminal used by the user, a network address 4633 of the packet relay apparatus executing authentication representing the packet relay apparatus executing authentication of the user, and an authentication condition 4634 representing the authentication result of the user.

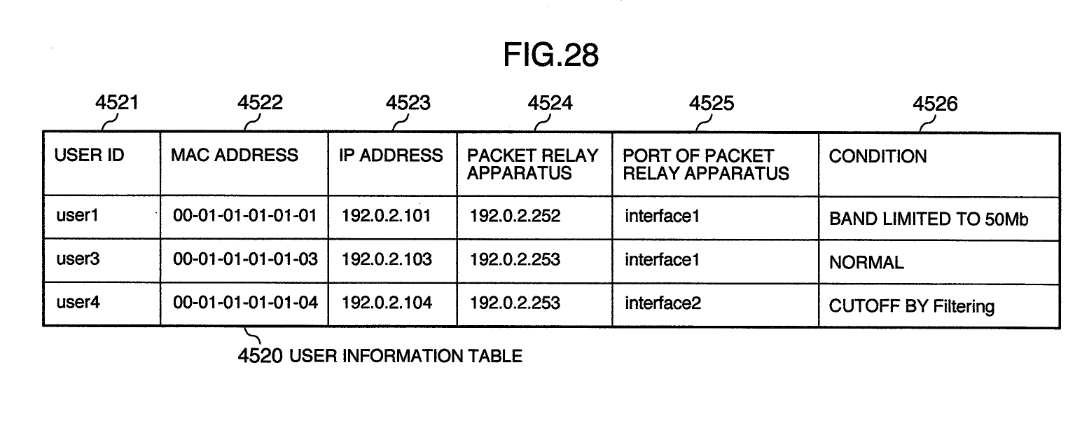

FIG. 28 shows an internal structure of a user information table 4520 held by the management server 4500. The user information table 4520 includes a user ID 4521 for identifying a user, a MAC address 4522 as identification information of the terminal used by the user, an IP address 4523 as the IP address allocated to the user terminal, a packet relay apparatus 4524 representing the packet relay apparatus connected to the user terminal, a port 4525 of the packet relay apparatus representing the interface connected to the user terminal of the relay apparatus and a condition 4526 representing the set content of the abnormal traffic countermeasure executed by the abnormal traffic detection apparatus 4400.

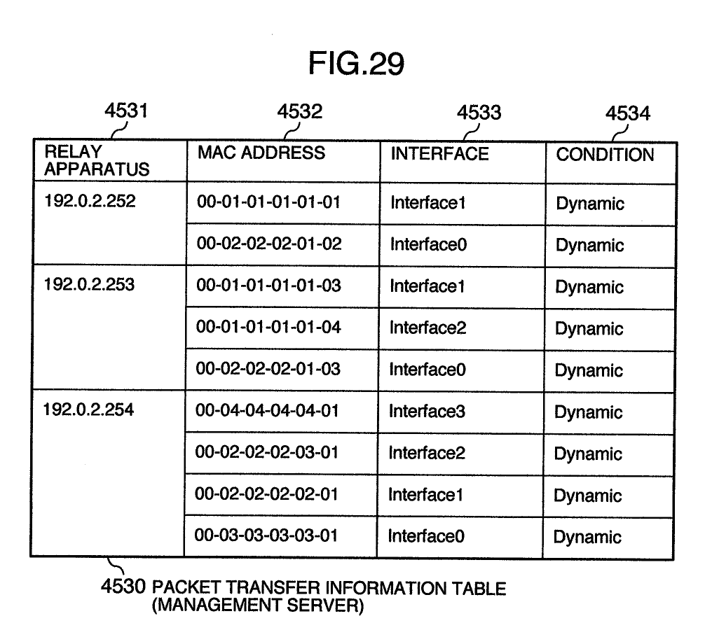

FIG. 29 shows an internal structure of a packet transfer information table 4530 held by the management server 4500. The packet transfer information table 4530 is the one that the management server described above acquires from the packet relay apparatuses 4100, 4200 and 4300 in the network shown in FIG. 19 and includes a relay apparatus 4531 representing the packet relay apparatus acquiring the packet transfer information table, an interface 4533 representing a network interface of the packet relay apparatus, MAC addresses as unique addresses of the apparatuses connected to the interface and a Type 4534 representing a learning method of these kinds of information by the packet relay apparatus.

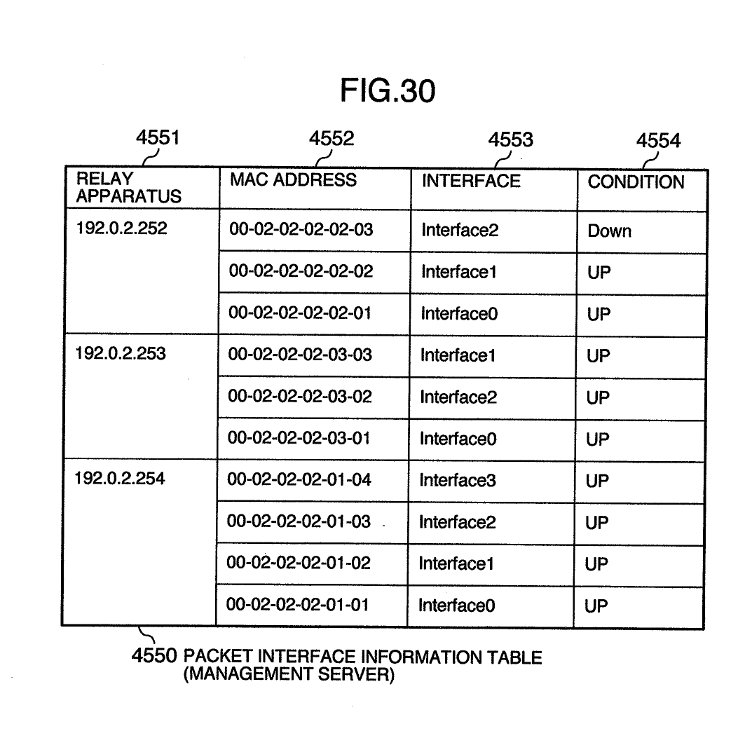

FIG. 30 shows an internal structure of an interface information table 4550 held by the management server 4500. The interface information table 4550 is the one that the management server described above acquires from the packet relay apparatuses 4100, 4200 and 4300 in the network shown in FIG. 19 and includes a relay apparatus 4551 representing the packet relay apparatus acquiring the interface information table, an interface 4553 for identifying the network interface, a MAC address as a unique address of the interface and a condition 4554 representing the condition of the interface.

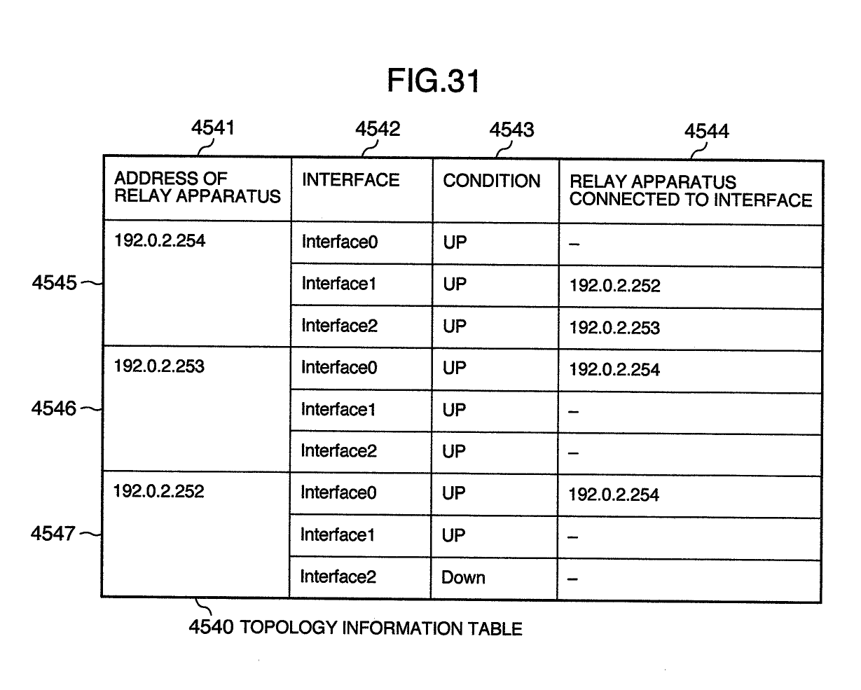

FIG. 31 shows an internal structure of a topology information table 4540 held by the management server 4500. The topology information table 4540 represents the connection among the packet relay apparatuses, includes a packet transfer information table 4530 and an interface information table 4550 and is used for specifying the packet relay apparatus to which the content of the abnormal traffic countermeasure method for each user, that is set in advance to the abnormal traffic countermeasure method table 350, is set. The topology information table includes the address 4541 of the packet relay apparatus representing the packet relay apparatus that acquires the packet transfer information as the original, an interface 4542 representing a network interface of this packet relay apparatus, a condition 4543 representing an operating condition of the interface and a relay apparatus 4544 connected to the interface representing the packet relay apparatus that is connected to the interface. In an entry 4545, for example, Interface0, Interface 1 and Interface 2 exist as the network interface for the packet relay apparatus of the IP address 192.0.2.254, and the packet relay apparatus of the IP address 192.0.2.252 is connected to the Interface1 while the packet relay apparatus of the IP address 192.0.2.253 is connected to the Interface2.

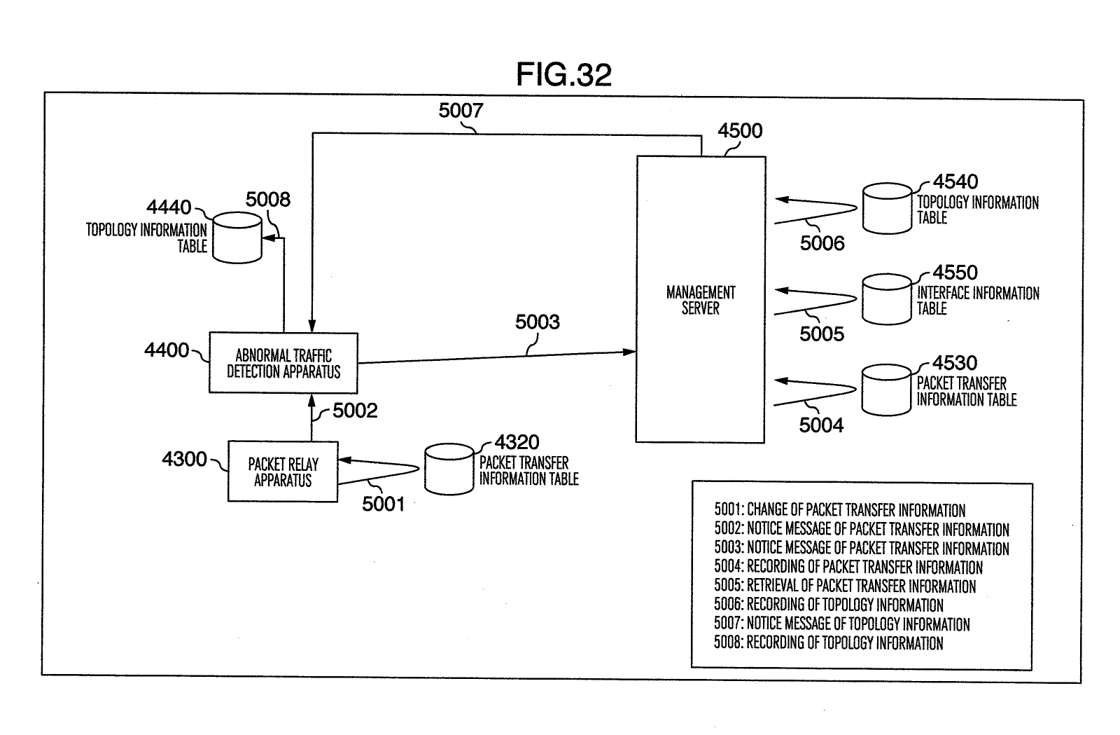

FIG. 32 shows the operation of the present system when the packet transfer information table of the packet relay apparatus 4300 changes. Numerals of from 5001 to 5008 in FIG. 32 represent the operations (or processing steps) in FIG. 32.

When the change of the operating condition of the network interface of the packet relay apparatus occurs or when the packet relay apparatus starts operating, the packet relay apparatus 4300 rewrites the packet transfer information table 4320 (step 5001). The packet relay apparatus then notifies the abnormal traffic detection apparatus 4400 of the change content of the packet transfer information table (step 5002). The abnormal traffic detection apparatus notifies the management server 4500 of the change content of the packet transfer information table from the packet relay apparatus (step 5003). The management server records the change content notified from the abnormal traffic detection apparatus to the packet transfer information table 4530 (step 5004) and updates the topology information table 4540 (step 5006) from the packet transfer information 4530 on which the change content is to be reflected and from the content of the interface information table 4550 (step 5004). The management server notifies the abnormal traffic detection apparatus 4400 of the content of the topology information table so updated (step 5007). The abnormal traffic detection apparatus 4400 updates the topology information table 400 by using the notice content from the management server (step 5008).

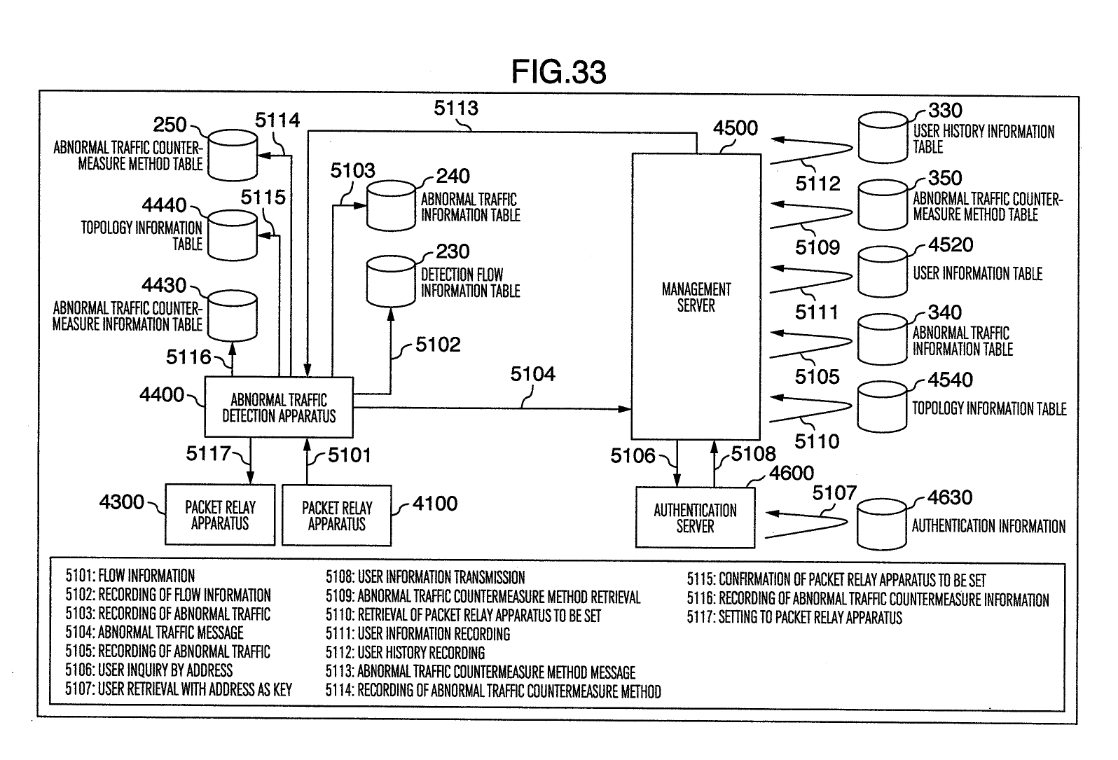

FIG. 33 shows the operation of the present system when the abnormal traffic detection apparatus 4400 detects the abnormal traffic. It is necessary as the premise in FIG. 33 in the same way as the operation of Embodiment 2 shown in FIG. 12 that authentication has already been completed by the authentication server in the user terminal used by the user. Reference numerals from 5101 to 5117 in FIG. 33 denote the operations (or processing steps) in FIG. 33.

First, the packet relay apparatus 4100 transmits the packet relayed by the packet relay apparatus 4100 as flow information in a predetermined cycle to the abnormal traffic detection apparatus 4400 (step 5101). The abnormal traffic detection apparatus records the flow information received from the packet relay apparatus to the detection flow information table 230 (step 5102). When the flow under recording in the detection flow information table 230 reaches the judgment condition of the abnormal traffic in the abnormal traffic detection apparatus, the flow ID of this flow, the flow information, the judgment result of the flow and the judgment time of the judgment as the abnormal traffic are recorded to the abnormal traffic information table 240 (step 5103) and transmits the abnormal traffic information message to the management server 4500 (step 5104).

The management server 4500 records the content of the abnormal traffic information message received from the abnormal traffic detection apparatus 4400 to the abnormal traffic information table 340 (step 5105). To determine from which user the abnormal traffic originates, the management server makes inquiry to the authentication server 4600 by using the MAC address recorded to the abnormal traffic information message (step 5106). The authentication server 4600 retrieves the user corresponding to the MAC address from the authentication information table 4630 by using the MAC address for inquiring the user from the management server (step 5107). The authentication server transmits the result of retrieval of the user (user information) from the authentication information table 4630 to the management server 4500 (step 5108). To acquire countermeasure information for the user transmitting the abnormal traffic, the management server retrieves the abnormal traffic countermeasure method table 350 on the basis of the user information received from the authentication server 4600 in step 5108 (step 5109). To determine to which packet relay apparatus the user terminal used by the user transmitting the abnormal traffic is connected, the management server retrieves the topology information table 4540 by using the MAC address of the user terminal (the MAC address used for the inquiry of the user information to the authentication server) (step 5110). The management server records the user information, the abnormal traffic countermeasure method corresponding to the user of the user information as the retrieval result, the IP address of the packet relay apparatus 4300 to which the user terminal used by the user is connected and the interface of the packet relay apparatus 4300 to which the user terminal is connected, to the user information table 4520 (step 5111). Furthermore, the management server records the user information and the abnormal traffic information received from the abnormal traffic detection apparatus 4400 (abnormal traffic information corresponding to this user information) to the user history information table 330 (step 5112). The management server thereafter transmits the countermeasure method for the user transmitting the abnormal traffic retrieved from the abnormal traffic countermeasure method table 350 and the information of the packet relay apparatus 4300 for executing setting of the countermeasure retrieved from the topology information table 4540 to the abnormal traffic detection apparatus 4400 (step 5113).

The abnormal traffic detection apparatus 440 records the countermeasure method for the user transmitting the abnormal traffic received from the management server 4500 in step 5113 to the abnormal traffic countermeasure method table 250 (step 5114), retrieves the information of the packet relay apparatus executing setting of the countermeasure received from the management server from the topology information table 4430 (step 5115), records the abnormal traffic countermeasure method for each user and its execution condition (step 5116) and executes setting in accordance with the countermeasure content to the packet relay apparatus 4300 (step 5117).

In this embodiment, the abnormal traffic countermeasure method is set in advance for each user by the management server 4500 and the user terminal of the user transmitting the abnormal traffic and the abnormal traffic are specified by inquiring the information of the abnormal traffic reported from the abnormal traffic detection apparatus 4400 to the authentication server 4600. The abnormal traffic countermeasure method is transmitted to the abnormal traffic detection apparatus 4400 by searching out from the topology information table 4540 the packet relay apparatus to which the user terminal is connected and the abnormal traffic countermeasure method is transmitted to the abnormal traffic detection apparatus 4400. Furthermore, setting for coping with the abnormal traffic is made from the abnormal traffic detection apparatus to the packet relay apparatus and the abnormal traffic countermeasure can be thus carried out for the user terminal connected to the packet relay apparatus to which the abnormal traffic detection apparatus is not connected.

### Embodiment 4

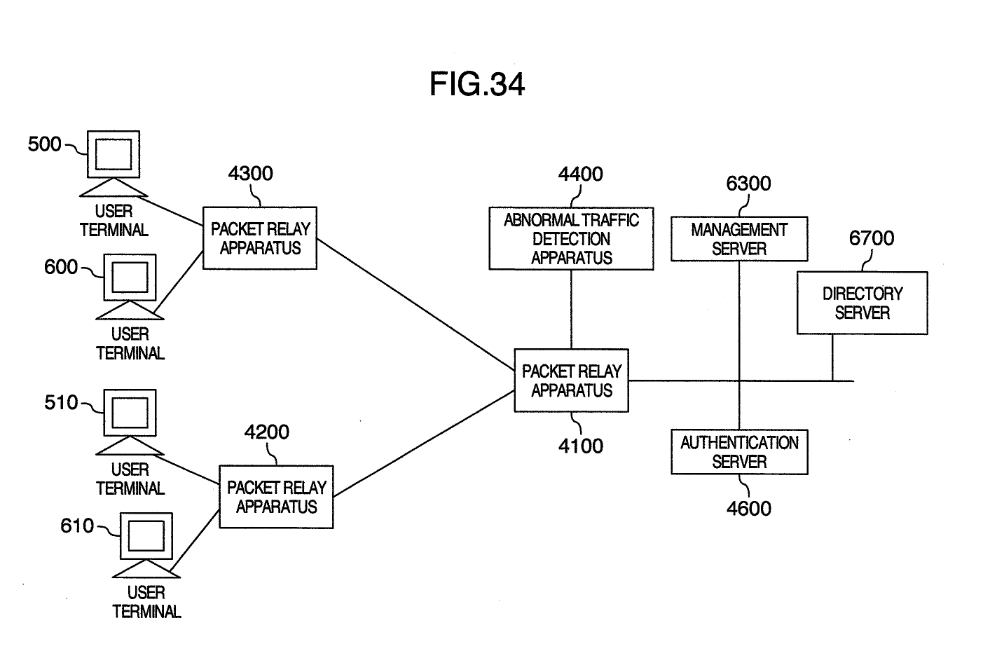

Still another embodiment of the invention will be explained. FIG. 34 shows a system configuration in which a directory server 6700 is added to the system of Embodiment 3 shown in FIG. 19. In this system, too, a system for coping with the abnormal traffic for a user terminal connected to the packet relay apparatus, to which the abnormal traffic detection apparatus is not directly connected, can be conducted by detecting and coping with the abnormal traffic for each user in the same way as in the system of Embodiment 3. Referring to FIG. 34, the directory server 6700 manages detailed information of users inside the system. A management server 6300 is constituted by adding a table for holding detailed information of the users to the management server 4500 shown in FIG. 19 and the rest of the constructions are the same as those of the management server 4500 in FIG. 19. Explanation will be omitted because the construction other than the management server 6300 in FIG. 34 and the directory server 6700 is the same.

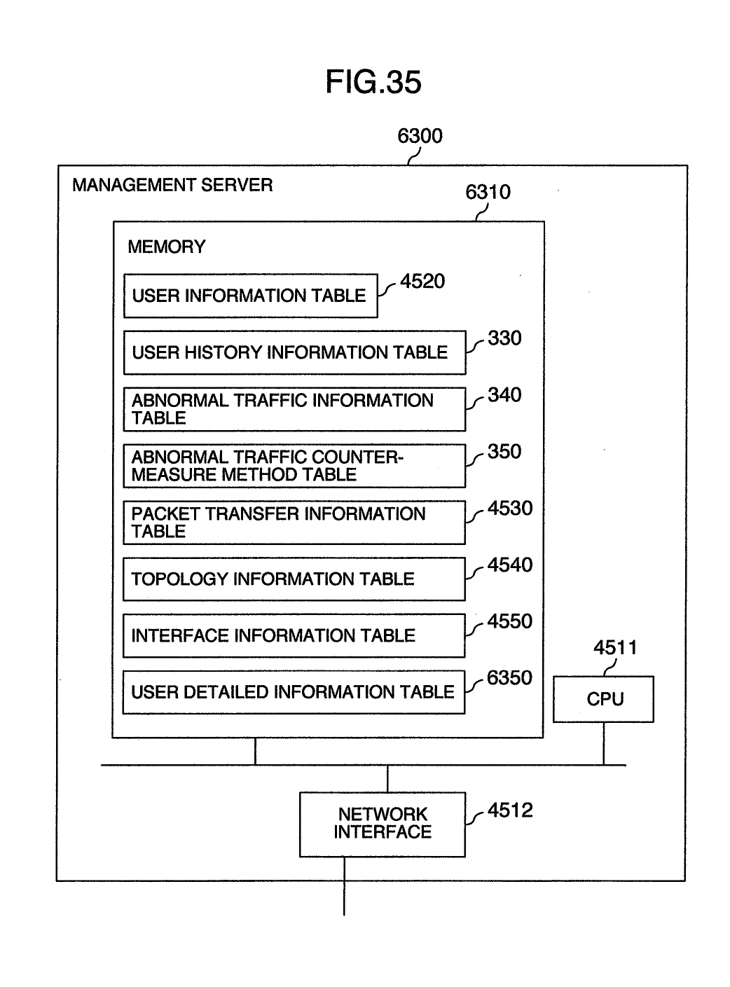

FIG. 35 shows an internal construction of the management server 6300. This server is constituted by adding a user detailed information table 6350 to the management server 4500 shown in FIG. 22 and the rest are the same. The user detailed information table 6350 of this management server holds the detailed information of the user that transmits the abnormal traffic and is inquired to the directory server 6700 in FIG. 34.

FIG. 36 shows an internal structure of a directory server 6700. The directory server includes a memory 6720, a CPU 6721 and a network interface 6722. The memory 6720 holds a user detailed information table 6730.

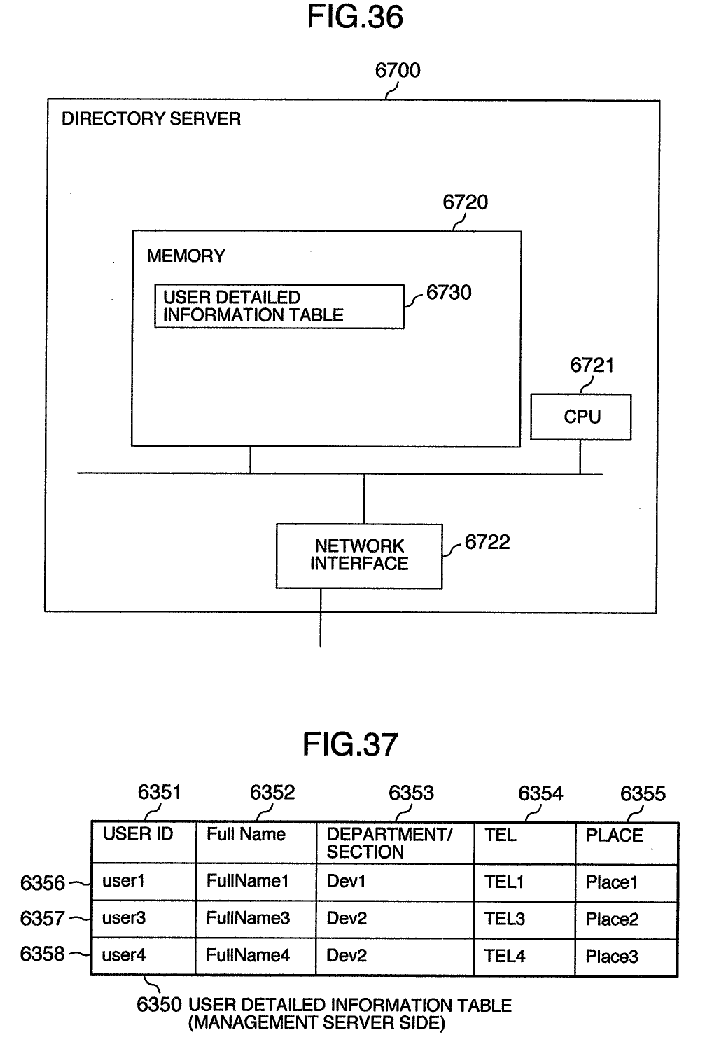

FIG. 37 shows an internal structure of a user detailed information table 6350 held by the management server 6300. The user detailed information table includes a user ID 6351 for identifying a user, Full Name 6352 representing the name of the user, department/section 6353 to which the user belongs in an organization, TEL 6354 for communicating with the user and a place 6355 at which the user mainly stays in the organization.

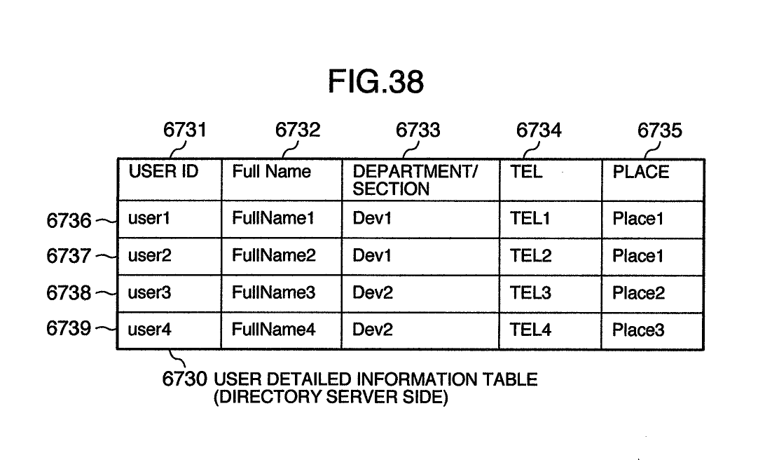

FIG. 38 shows an internal structure of a user detailed information table 6730 held by the directory server 6700. The user detailed information table includes a user ID 6731 for identifying a user, Full Name 6732 representing the name of the user, department/section 6733 to which the user belongs in an organization, TEL 6734 for communicating with the user and a place 6735 at which the user mainly stays in the organization.

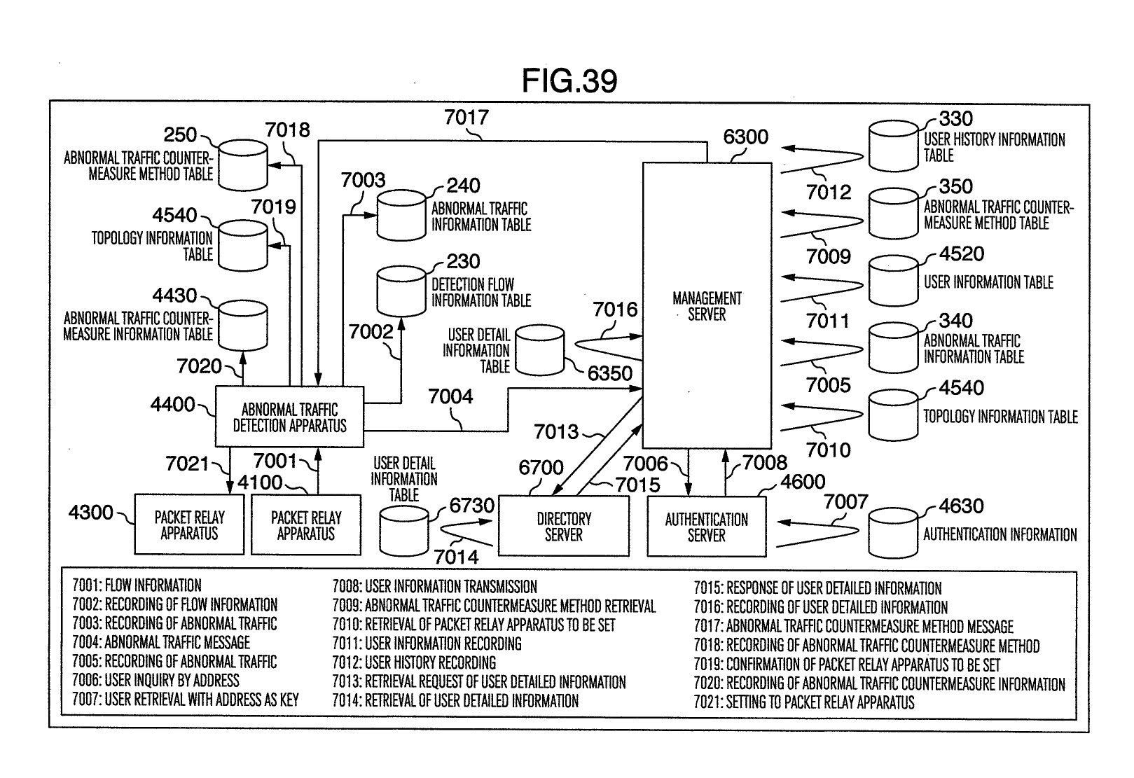

FIG. 39 shows the operation of the present system when the abnormal traffic is detected in Embodiment 4. Numerals from 7001 to 7021 in FIG. 39 denote the operation (or processing steps) in FIG. 39. Steps 7001 to 7012 in FIG. 39 is the same as steps 5101 to 5112 in FIG. 33 and explanation will be therefore omitted. Step 7017 in FIG. 39 is similar to step 5113 in FIG. 33, step 7018 is similar to step 5114, step 7019 is similar to step 5115, step 7020 is similar to step 5116 and step 7021 is similar to step 5117. Therefore, explanation will be omitted. To record the detailed information of the user transmitting the abnormal traffic in addition to the processing of the management server 4500 shown in FIG. 33, the management server 6300 inquires the detailed information of this user to the directory server 6700 after step 7012 (step 7013). The directory server retrieves the detailed information of the user from the user detailed information table 6730 by using the user inquired from the management server as a key (step 7014) and transmits the detailed information of the user as the retrieval result to the management server 6300 (step 7015). The management server records the user detailed information received from the directory server 6700 to the user detailed information table 6350 (step 7016).

This embodiment records the detailed information of the user transmitting the abnormal traffic (user ID, user name, department/section inside organization, telephone number, etc) in addition to the content of the system of Embodiment 3 to the management server 6300. Therefore, the user can be directly identified when the manager refers to the user detailed information in addition to the countermeasure against the user terminal.

### Embodiment 5

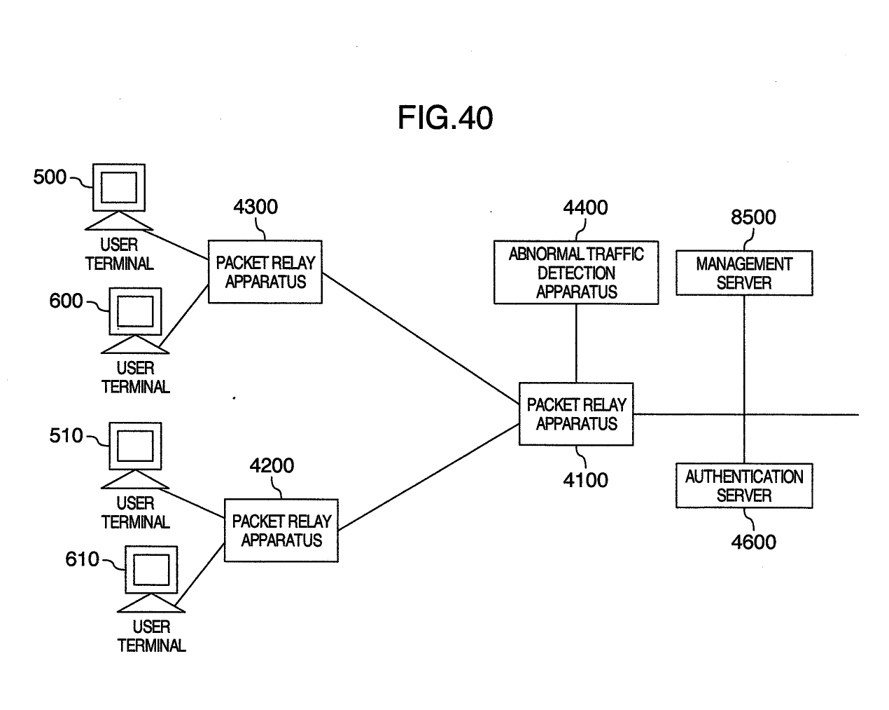

Still another embodiment of the invention will be explained. FIG. 50 shows a construction that is the same as the construction of Embodiment 3 shown in FIG. 19 but is different in only the traffic countermeasure method table of a management server. Therefore, detailed explanation of FIG. 40 will be omitted.

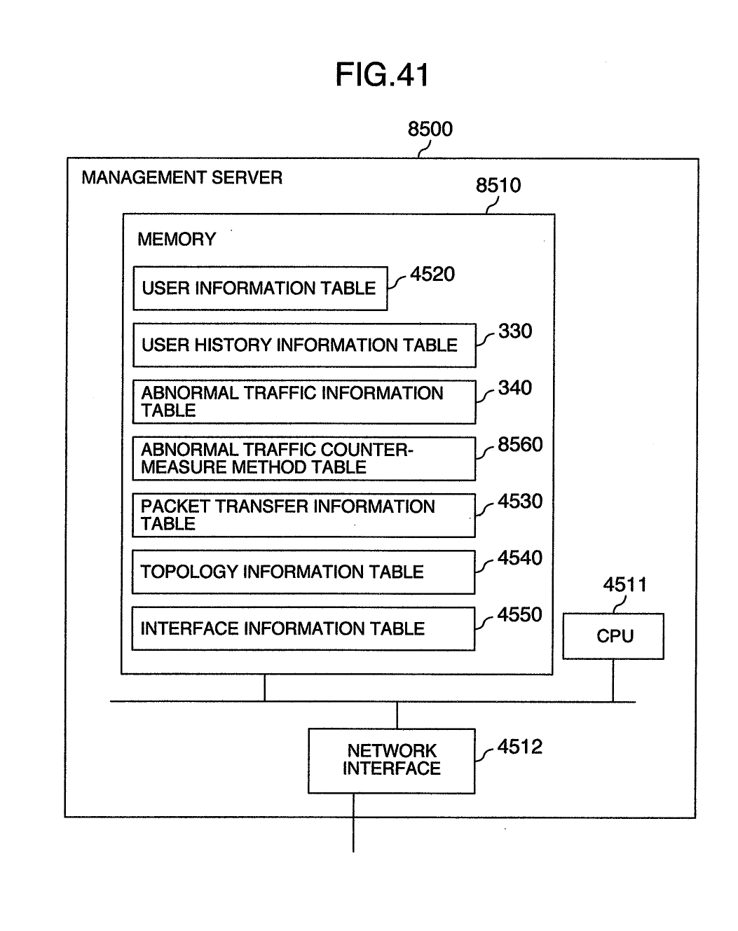

FIG. 41 shows an internal structure of a management server 8500. The management server 8500 includes a memory 8510, a CPU 4511 and a network interface 4512. The memory 8510 has the same internal structure as the memory 4510 of the management server 4500 in FIG. 22 with the exception of the abnormal traffic countermeasure method table 8500.

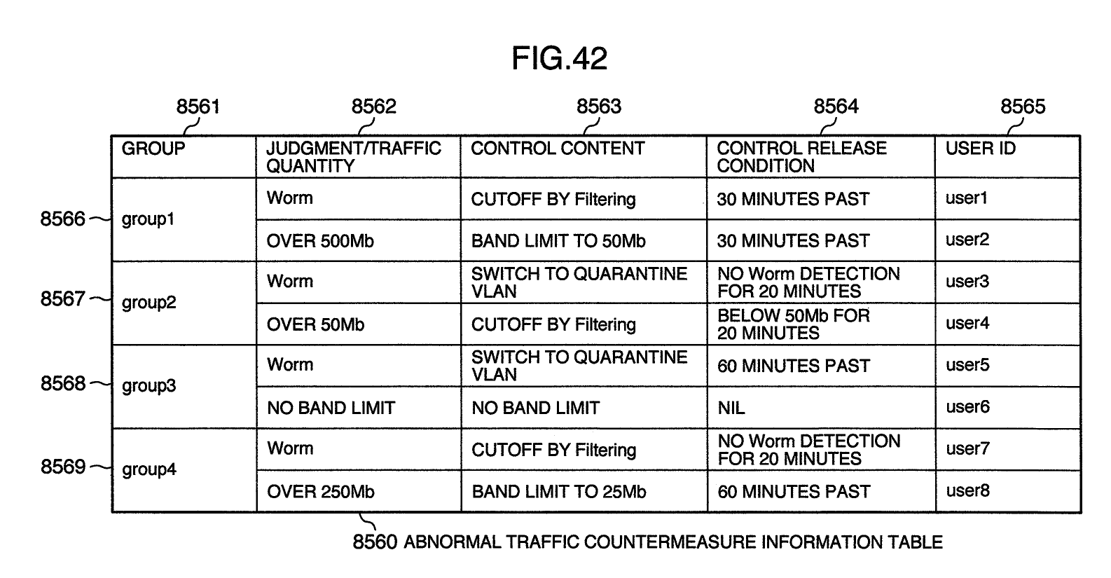

FIG. 42 shows an internal structure of the abnormal traffic countermeasure method table 8560 held by the management server 8500. The abnormal traffic counter measure method table 8560 contains a countermeasure method (solution for the abnormal traffic) for each user against the abnormal traffic. The abnormal traffic countermeasure method table 8560 includes an identifier for identifying the abnormal traffic countermeasure method or a group 8561 for grouping the user designating the same abnormal traffic countermeasure method, a judgment/traffic quantity 8562 representing the content of an object when the abnormal traffic is detected, a control release condition 8564 representing a judgment condition when the abnormal traffic is no longer detected and a user ID 8565 representing a user as an object when the abnormal traffic is detected. User1 and user2 of the abnormal traffic countermeasure method table belong to the group of the same countermeasure condition and the same abnormal traffic countermeasure method is applied to them.

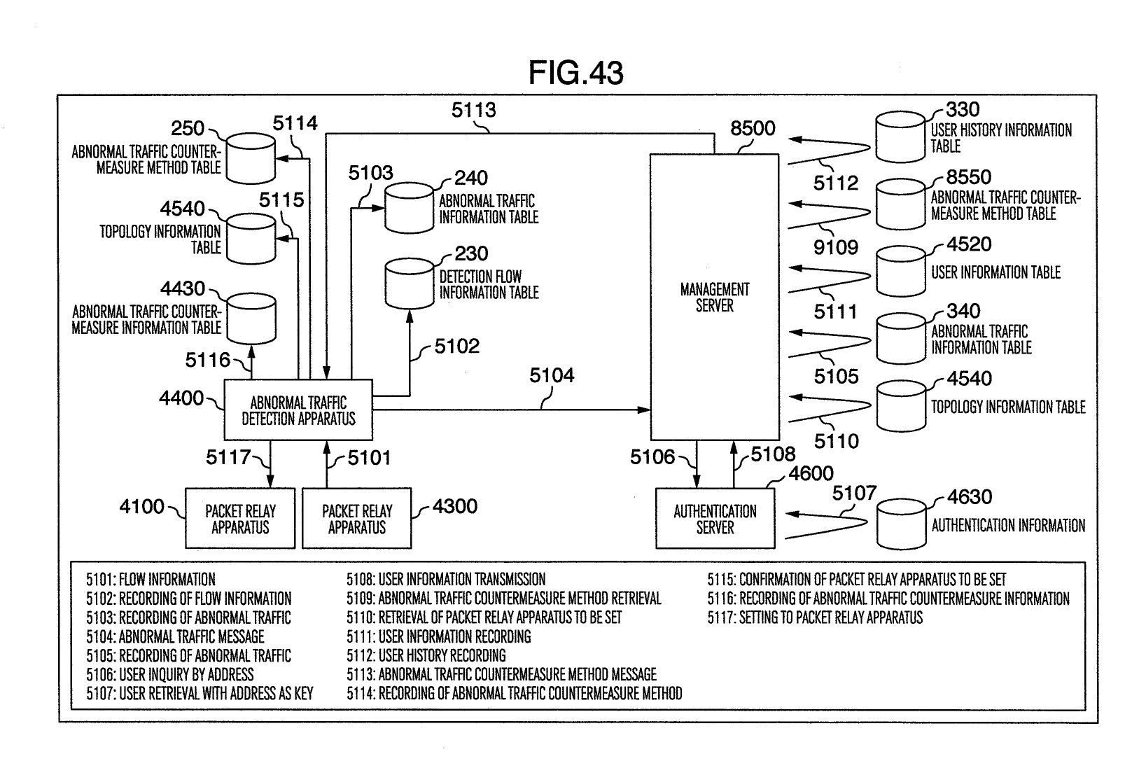

FIG. 43 shows the operation of the present system when the abnormal traffic is detected in Embodiment 5. Numerals from 5101 to 6117 and 9109 in FIG. 43 denote the operation (or processing steps) in FIG. 43. Steps other than step 9109 in FIG. 43 are the same processing as the steps in FIG. 33, explanation of these members will be omitted. In step 9109, the management server 8500 retrieves the countermeasure method for the user transmitting the abnormal traffic from the abnormal traffic countermeasure method table 8550 by using the user as a key and acquires the group to which the user belongs and the abnormal traffic countermeasure method of that group. The management server 8500 uses this abnormal traffic countermeasure method as the abnormal traffic countermeasure method of the user. According to the system that groups the users having the same content of the abnormal traffic countermeasure method, the manager is required to input the abnormal traffic countermeasure method for each group but not for each user. Therefore, the trouble of the input operation of the abnormal traffic countermeasure method can be saved.

It should be further understood by those skilled in the art that although the foregoing description has been made on embodiments of the invention, the invention is not limited thereto and various changes and modifications may be made without departing from the spirit of the invention and the scope of the appended claims.

1. A traffic control system for controlling traffic of a network, comprising:
a user terminal used by a user;
a packet relay apparatus connected to said user terminal and relaying a packet;
an abnormal traffic detection apparatus for detecting abnormal traffic on the basis of flow information about the packet relayed by said packet relay apparatus; and
a management server connected to said abnormal traffic detection apparatus;
wherein said abnormal traffic detection apparatus stores the flow information received from said packet relay apparatus and transmits abnormal traffic information detected on the basis of the flow information to said management server;
said management server stores the abnormal traffic information transmitted from said abnormal traffic detection apparatus in association with identification information of said abnormal traffic detection apparatus transmitting the abnormal traffic information, stores a countermeasure method coping with the abnormal traffic for each user, stores the abnormal traffic information for each user on the basis of the abnormal traffic information transmitted, and transmits the countermeasure method corresponding to the abnormal traffic contained in the abnormal traffic information transmitted from said abnormal traffic detection apparatus among the abnormal traffic countermeasure methods stored, to said abnormal traffic detection apparatus.

2. A traffic control system according to claim 1, which further comprises:
an authentication server for storing authentication information of a user using said user terminal; and
wherein said management server transmits an address unique to said user terminal contained in said abnormal traffic information to said authentication server; and
said authentication server transmits the user information corresponding to the transmitted address to said management server.

3. A traffic control system according to claim 1, wherein said management server associates the abnormal traffic information transmitted from said abnormal traffic detection apparatus with each user and stores it as user history information.

4. A traffic control system according to claim 1, wherein said abnormal traffic detection apparatus stores the countermeasure method transmitted from said management server in association with the user information, and transmits information for executing setting in accordance with said countermeasure method to said packet relay apparatus.

5. A traffic control system according to claim 1, which further comprises:
an address management server for storing an address unique to said user terminal, an address allocated to said user terminal and an allocation term of the address allocated in association with one another; and
wherein said management server transmits the allocated address contained in the abnormal traffic information to said management server; and
said address management server retrieves an address unique to the corresponding user terminal on the basis of the address transmitted, and transmits the address information to said management server.

6. A traffic control system according to claim 5, wherein said management server transmits an address transmitted from said address management server to said authentication server; and
said authentication server transmits information for specifying a corresponding user to said management server on the basis of the address transmitted.

7. A traffic control system according to claim 6, wherein said management server retrieves an abnormal traffic countermeasure method corresponding to the information for specifying a user that is transmitted from said authentication server, and transmits the abnormal traffic countermeasure method to said abnormal traffic detection apparatus.

8. A management server for managing traffic of a network, comprising:
a network interface portion for receiving abnormal traffic information based on flow information of a packet in a network;
an abnormal traffic information storage portion for storing the abnormal traffic information received;
an abnormal traffic countermeasure method storage portion for storing a countermeasure method corresponding to the abnormal traffic information for each user;
a user information storage portion for storing a control content contained in said countermeasure method so stored in association with each user;
a user history information storage portion for storing the received abnormal traffic information as history of each user; and
a control portion for retrieving a countermeasure method for coping with the received abnormal traffic information, for a user corresponding to the abnormal traffic information from inside said abnormal traffic countermeasure method storage portion.

9. A management server according to claim 8, wherein said control portion transmits set information for controlling packet transmission of a user terminal corresponding to the abnormal traffic information on the basis of the countermeasure method retrieved.

10. A traffic control system according to claim 1, wherein said management server stores information of a packet relay apparatus to which said user terminal is connected, selects a packet relay apparatus to which the countermeasure method is to be set from among said packet relay apparatuses and transmits the information of said packet relay apparatus selected to said abnormal traffic detection apparatus.

11. A traffic control system according to claim 10, wherein said management server create the information of said packet relay apparatus stored from packet transfer information held by said packet relay apparatus and interface information.

12. A traffic control system according to claim 10, which further comprises:
an authentication server for storing authentication information of a user utilizing said user terminal; and
a directory server for managing detailed information of the user; and
wherein said management server transmits an address unique to said user terminal and contained in the abnormal traffic information to said authentication server;
said management server transmits the user information transmitted from said authentication server to said directory server;
said directory server transmits detailed information of the user corresponding to the user information transmitted, to said management server; and
said management server stores the detailed information transmitted from said directory server.

13. A traffic control system according to claim 12, wherein the user information contains at least user ID for identifying the user, and the user detailed information contains at least any of user name, user post, telephone number and place.

14. A traffic control system according to claim 10, wherein said abnormal traffic detection apparatus stores a countermeasure method transmitted from said management server in association with the user information and transmits information for executing setting in accordance with the countermeasure method to said packet relay apparatus to which the countermeasure method transmitted from said management server is to be set.

15. A traffic control system for controlling traffic in a network, comprising:
a user terminal used by a user;
a packet relay apparatus connected to said user terminal and relaying a packet;
an abnormal traffic detection apparatus for detecting abnormal traffic on the basis of flow information about the packet relayed by said packet relay apparatus; and
a management server connected to said abnormal traffic detection apparatus;
wherein said abnormal traffic detection apparatus stores the flow information received from said packet relay apparatus and transmits abnormal traffic information detected on the basis of the flow information to said management server;
said management server stores the abnormal traffic information transmitted from said abnormal traffic detection apparatus in association with identification information of said abnormal traffic detection apparatus transmitting the abnormal traffic information, stores a countermeasure method coping with the abnormal traffic for each user group, stores the abnormal traffic information for each user on the basis of the abnormal traffic information transmitted, and transmits the countermeasure method corresponding to the abnormal traffic contained in the abnormal traffic information transmitted from said abnormal traffic detection apparatus among the abnormal traffic countermeasure methods stored, to said abnormal traffic detection apparatus.

16. A management server for managing traffic of a network, comprising:
a network interface portion for receiving abnormal traffic information on the basis of flow information of a packet in a network;
an abnormal traffic countermeasure method storage portion for storing a countermeasure method corresponding to abnormal traffic information for each user group; and
a user history information storage portion for storing the abnormal traffic information received as history of each user.

17. A traffic control system according to claim 1, wherein the countermeasure method contains at least any of cutoff by filtering, band limit and VLAN switch.
